(19) United States
(12) Patent Application Publication
(10) Pub. No.: US 2026/0192409 A1
(43) Pub. Date: Jul. 9, 2026

(54) MACHINE CHIP AND COOLANT FLOW CLEANING SYSTEM FOR ENDLESS BELT CONVEYOR

(71) Applicant: Mayfran International Inc., Cleveland, OH (US)

(72) Inventors: Mark Andrew Mandzukic, Strongsville, OH (US); Michael Charles Gervasi, Aurora, OH (US); Nebojsa Petrovic, Seven Hills, OH (US); Wilhelmus Jacobus Cornelia Welten, Mayfield Village, OH (US); Mehmet Murat Yuksel, Mayfield Village, OH (US)

(21) Appl. No.: 19/434,830

(22) Filed: Dec. 29, 2025

Related U.S. Application Data
(60) Provisional application No. 63/742,549, filed on Jan. 7, 2025.

(51) Int. Cl. B23Q 11/10; B01D 33/073; B01D 33/48; B01D 33/80; B23Q 11/00

(52) U.S. Cl. CPC B23Q 11/1069; B01D 33/073; B01D 33/48; B01D 33/806; B01D 33/807; B23Q 11/0042

(57) ABSTRACT

Systems, devices, and methods that enable solid and liquid pourable materials to more efficiently and properly exit intermediate conveyor areas between upper and lower runs of a conveyor, grab and carry high volume of materials from the upper run to a discharge area, and provide better access to wear parts and/or components.

### REFERENCED APPLICATIONS

The present application claims priority on U.S. Provisional Patent Application Ser. No. 63/742,549 filed Jan. 7, 2025, which is fully incorporated herein by reference.

### FIELD OF DISCLOSURE

The present disclosure relates generally to conveyor devices and apparatuses used therewith, and more particularly to conveyor devices and apparatuses used therewith that: (i) improve in separating chippings/fines and cooling liquid accumulating on machine tools; (ii) address floating chip/fines issues, while handling higher coolant flows; (iii) improve serviceability of the conveyor devices and the apparatuses used therewith; and/or (iv) require less and/or easier maintenance, while providing longer longevity to the conveyor devices and the apparatuses.

### BACKGROUND OF DISCLOSURE

Conveyors can enable removal of pourable conveying material (e.g., bulk materials) that accumulate when machining metallic and composite materials (such as steel, aluminum, brass, and others), especially chips. In such cases, the resulting material, often together with a liquid coolant and/or lubricant is supplied from the conveyor for disposal or recycling. The conveyor may at the same time have a filter function with which the liquid coolant and/or lubricant is separated from the solid material and fed to a further use or to a collective supply. The endless belt may have different configurations and, for example, be designed strap, band or belt-shaped, or be designed as a hinge with cleats. Non-limiting examples of prior art conveyor systems are disclosed in U.S. Pat. Nos. 7,115,200; 7,485,226; 7,563,369; 7,648,632; 10,994,936; 7,014,760; and 7,014,764, and U.S. Patent Publication No. 2010/0012564, each of which is incorporated by reference herein in its entirety.

In conveyors with endless belts, the endless belt is typically guided between at least two deflecting apparatuses and passes through an upper path, referred to below as the upper run, and a lower path, referred to below as the lower run. Generally, the upper run serves to convey the material to be conveyed from a loading area to an unloading area, while the lower run represents the return run.

It cannot be ruled out that parts of the material to be conveyed reach the area between the upper run and the lower run, referred to below as the intermediate space (e.g., intermediate conveyor area, etc.), and following gravity end up on an intermediate space side of the endless belt in the lower run, the intermediate space side facing the upper run. If the pourable conveying material consists of chips from material processing, these generally have a length from under about 1 mm to about 10 mm and more. The material which has reached the intermediate space side of the endless belt in the lower run is referred to below as the intermediate space material. Lying on the driven endless belt, the intermediate space material gets into the area of the belt return, where it can contaminate parts of the belt return device, such as gears or pulleys, or pile up on it. The intermediate space material, which does not adhere to the belt return device, in turn falls on the intermediate space side of the endless belt in the lower run and can thus again reach the belt return device. With additional material which passes through the upper run or past it into the intermediate space, the intermediate space material continuously accumulates in the area of the belt return device. In particular, chips tend to snag and form larger clew-like structures. It may cause malfunction or damage in the area of the belt return device, which may require expensive cleaning, repair or maintenance.

In many cases, buildup of material in the intermediate space that do not have the means to exit successfully can cause excess buildup of coolant and such materials, cause damage to internal components, and lead to failures in the conveyor. Such measures are required to ensure proper exit of pourable liquid and solid conveying material and access to wearable components to ensure longevity and proper maintenance of such wearable items. In continuous machining environments, such pourable liquid and solid materials need a reliable exit point in the intermediate space between the upper and lower runs of the conveyor belt.

Furthermore, in cases where heavy machining of liquid and solid pourable materials is in place, long and heavy chips can act as a barrier, preventing a proper path for desirable liquid flows. As a result, in heavy machining operations where there is a high amount of solid and liquid materials that need to be managed, performance of existing cleats can be affected if there is not enough area to grab materials along the upper runs and carry the material out effectively to the designated discharge. As higher volume of materials build up, restrictions of solid and liquid material flows can cause overflow and maintenance frustrations of such materials. When such high-volume materials and liquids discharge from machining processes and fall onto the upper run belt, materials can act as a barrier and cause maintenance issues, inadequate flow of liquids, and overflow. Without a proper measure in place to carry out bulky materials in a timely fashion, problems may arise, and effectiveness of operation may be jeopardized.

Additionally, in mechanical conveyor designs where a filter is present, the wear parts are often in an inadequate location causing extensive operation downtime and labor to replace parts and perform preventative maintenance. In most cases, conveyor frames must be disassembled to access wear parts for maintenance.

As such, there is an ongoing need for conveyor devices and apparatuses used therewith that (i) improve in separating chippings/fines and cooling liquid accumulating on machine tools; (ii) address floating chip/fines issues, while handling higher coolant flows; (iii) improve serviceability of the conveyor devices and the apparatuses used therewith; and/or (iv) require less and/or easier maintenance, while providing longer longevity. The disclosed systems advantageously: (i) allow first and second conveyor systems to be flush with one another; (ii) provides lower profile configurations and applications of the first and second conveyor systems; (iii) eliminates floating chips/fines; and (iv) eliminates mating flanges of the first and second conveyor systems for ease of manufacturability.

### SUMMARY OF THE DISCLOSURE

The present disclosure relates conveyor devices and apparatuses that: (i) improve in separating chippings/fines and cooling liquid accumulating on machine tools; (ii) address floating chip/fines issues, while handling higher coolant flows; (iii) improve serviceability of the conveyor devices and the apparatuses used therewith; and/or (iv) require less and/or easier maintenance, while providing longer longevity to the conveyor devices and the apparatuses. The present disclosure also relates to conveyor devices and apparatuses that: (a) allows first and second conveyor systems to be flush with one another; (b) provides lower profile configurations and applications of the first and second conveyor systems; (c) eliminates floating chips/fines; and/or (d) eliminates mating flanges of the first and second conveyor systems for ease of manufacturability.

The present disclosure relates to configurations and designs for conveyor devices and apparatuses such as endless belt conveyors enabling solid and liquid pourable materials a more efficient way for such materials to properly exit the intermediate conveyor area (e.g., area located between the upper and lower runs, or the upper run of the conveyor belt and the upper surface of the bottom of the frame of the conveyor system) so as to grab/retain and carry high volume of materials from the upper run to the discharge area, and better access to wear parts among the filter areas. In machining operations where materials such as liquid coolants are used, metals including but not limited to steel, aluminum, brass, and others are present, processes need a means to be separated from the liquid coolant for use in scrap, recycling, or other purposes in an efficient manner, and by a process that extends the longevity of the device used in such separate, and uses a device is has increased ease in maintenance. Within the confines of many operations that require high volume of liquid and solid pourable materials, without proper measures integrated to control materials and convey them to proper locations, results can include equipment breakdown of parts of the conveyor devices and apparatuses, expedited wear on components of the conveyor devices and apparatuses, failure of conveyors used on the conveyor devices and apparatuses, and extended downtime and labor for repairs associated with the conveyor devices and apparatuses. One or more of the disclosed systems, separation devices, and methods in accordance with the present disclosure are configured to a) aid in directing the pourable solid and liquid materials that are located in an intermediate conveyor area to be properly processed, b) process higher volumes of metal chips, scrap, etc. to the desired discharge location, and/or c) provides easier access to filter wear parts on the device.

In one or more non-limiting aspect of the disclosure, the disclosed systems, separation devices, and methods are configured to include one or more flume/trough systems that are optionally configured to receive a flow of liquid and solid materials from a) an intermediate conveyor area between the upper and lower runs of the conveyor belt or the upper run of the conveyor belt and the upper surface of the bottom of the frame of the conveyor system, and/or b) other locations on and/or about the upper and lower runs of the conveyor belt. The one or more flume/trough systems can include one or more of a) one or more enclosed troughs that directs liquids and solids to a particular location (e.g., toward a filter drum, etc.); b) one or more sloped troughs that facilitates in directing liquids and solids to a particular location (e.g., toward a filter drum, etc.); c) one or more openings in the frame to enable liquid flow and particle flow from the intermediate conveyor area and into the one or more troughs; d) a flushing arrangement that is configured to add fluid to the one or more troughs so as to facilitate in maintaining certain liquid volumes and/or flow rates in the one or more troughs to thereby facilitate in directing liquids and solids to a particular location (e.g., toward a filter drum, etc.); e) one or more level monitors and/or sensors to monitor fluid levels in the one or more troughs which can be used to i) cause additional fluid to be added to the one or more troughs to maintain certain liquid volumes and/or flow rates in the one or more troughs, and/or ii) to increase or decrease the volume of liquid and solid materials added to the separation device so to I) prevent overloading and/or causing overflowing of fluid and material from the one or more troughs, II) prevent fully filling and/or causing an overflow in the intermediate conveyor area between the upper and lower runs of the conveyor belt by the fluid and material, and/or III) prevent starving or unacceptable low flow rates in the one or more troughs; and/or f) a wide feed opening into a filter arrangement (e.g., filter drum, etc.) to accommodate large fluid flow rates and to assure proper and desired flow rate of the liquid into the filter arrangement. In one non-limiting embodiment, the one or more modular flume/trough systems include a structure that receives liquid and solid materials from one or more frame opening slots that are located at or about the intermediate conveyor area between the upper and lower run, and wherein the one or more frame opening slots allow the liquid and solid material in the intermediate conveyor area to exit or flow out of the intermediate conveyor area and into the one or more troughs. The number and/or size of the one or more openings are non-limiting. The size and shape of the one or more troughs are non-limiting. In another non-limiting embodiment, the one or more modular flume/trough system functions or acts as a gateway or passageway for pourable solid and liquid material to provide a constant flow towards the filter arrangement (e.g., filter drum, etc.). In another non-limiting embodiment, the one or more modular flume/trough system can optionally be a bolted design that has the flexibility to increase in height, length, and/or width so as to allow for integration with various conveyor designs, types, and/or sizes. The modular design advantageously allows for maintenance access points and/or adjustments for effective operation.

In another and/or alternative non-limiting aspect of the disclosure, the disclosed systems, devices, and methods are optionally configured to include one or more retractable cleat systems. In one non-limiting embodiment, the disclosed one or more retractable cleat systems can be an extension of standard bar cleats which are positioned in predetermined distances along the entirety of conveyor belt assemblies designed to help carry bulk materials a certain distance to a discharge or material handling process. The number and/or height of the retractable cleats may vary depending on the application (type of materials being moved, volume, etc.). Cleat height may have certain limitations based on conveyor framing footprints. The retractable cleat system may or may not be used with standard non-retractable cleats. In another non-limiting embodiment, the one or more retractable cleat systems includes a spring or other biasing arrangement and/or a hinge mechanism to enable the retractable cleat to move between a retracted position and a raised position. When the retractable cleat is in the retracted position, the cleat profile is low so as to not take up space that would result in widening the spacing between the upper and lower conveyor runs. Generally, each of the retractable cleats are in the retracted position as the retractable cleat is moving on the lower run portion of the upper conveyor belt. Also, each of the retractable cleats are in the raised position as the retractable cleat is moving on the upper run portion of the upper conveyor belt, wherein in the upper run portion is used to move the bulk materials. When the retractable cleat is in the raised positioned, the retractable cleat forms an increased amount of surface area and thereby allows for a) more materials to be grabbed and carried out to the discharge area so as to discharge higher volumes of material, and/or b) facilitates in alleviating chances of overflow and unexpected maintenance repairs while the retracted cleat is in the raised position. In another non-limiting embodiment, as the conveyor belt transitions from the lower to the upper run, the one or more retractable cleats can be configured to move from the retracted position to the raised position. In another non-limiting embodiment, as the conveyor belt transitions from the upper to the lower run, the one or more retractable cleats can be configured to move from the raised position to the retracted position. The frame of the conveyor and/or the retractable cleat can include one or more features to enable the raising and retracting of the retractable cleat. In one non-limiting configuration, the frame about the upper conveyor belt includes one or more flanges and/or other structures that engage a portion of the retractable cleat to cause the retractable cleat to move from the raised position to the retracted position when the upper conveyor belt transitions from the upper to the lower run, and when the upper conveyor belt transitions from the lower to the upper run, the one or more flanges and/or other structures disengage form the retractable cleat to enable the retractable cleat to move from the retracted to the raised position. As can be appreciated, other and/or additional arrangements can be used to cause the raising and lowering of the retractable cleats.

In another and/or alternative non-limiting aspect of the disclosure, the disclosed systems, devices, and methods are optionally configured to include one or more retractable cleat systems that have a tooth configuration and/or other non-constant linear shape along the width of the retractable cleat. The tooth-shape and/or other non-constant linear shape is configured to facilitate in grabbing materials on the upper run of the upper conveyor so that such material can be effectively and efficiently conveyed away by the upper conveyor.

In another and/or alternative non-limiting aspect of the disclosure, the disclosed systems, devices, and methods are optionally configured to include one or more filter arrangement (e.g., filter system, etc.) to filter and/or separate material from the liquid. In non-limiting embodiment, the filter arrangement includes a filter system. In one non-limiting configuration, the filter drum of the filter system includes a frame (e.g., cylindrical shaped frame, etc.) and a filter medium that is connected to the frame. The filter medium can be connected to the inner and/or outer surface of the frame. The type of connection arrangement used to connect the filter to the frame is non-limiting (e.g., adhesive, clamp, screws, bolts, weld, solder, melted connection, snaps, clips, tie downs, mechanical connection, magnetic connection, etc.). One or more layers of filter material can be used. The type of material used to form the filter material is non-limiting (e.g., metal, plastic, fabric, composite material, polymer material, etc.). The thickness of the filter material is non-limiting. The pore size of the filter material is non-limiting (e.g., 1-300 micron pore size and all values and ranges therebetween). In another non-limiting embodiment, the filter system includes one or more filter systems, one or more seals, and other wear internal parts that are configured to be accessible from the external sides of the conveyor. In one particular configuration, the filter system optionally includes one or more removable outer caps, one or more bearings, and/or one or more seals that enable a user to remove the one or more removable outer caps, one or more bearings, and/or one or more seals to easily access and service and/or inspect the filter drum without having to disassemble the conveyor belts. In another non-limiting configuration, the one or more outer caps, one or more bearings, and/or one or more seals may be formed of ultra-high molecular weight polyethylene (UHMW) material, hardened steel, other materials with/without imprinted grooves, or combinations thereof. In another non-limiting embodiment, the outer drum seal assemblies can optionally be bolted to the outside of the conveyor frame. As maintenance is needed, fittings such as screws, nuts, bolts, or other, can be quickly disconnected for access to seal replacement and other internal wear parts, thereby significantly decrease labor time and increase uptime of operations (e.g., to facilitate in the cleaning, removal, and/or replacement of the filter, the filter drum, the seals, and/or other components, etc.). In another non-limiting embodiment, the filter drum of the filter arrangement optionally is rotatable. The filter drum can be optionally rotated by a motor, and/or engagement with one or both of the conveyor belts. In one non-limiting configuration, the filter drum is configured to engage the belt of the lower conveyor and caused to be rotated during the movement of the lower conveyor. In another non-limiting embodiment, the filter arrangement optionally includes a filter flushing arrangement that applies (e.g., sprays. etc.) liquid on/to the filter material to partially or fully clean the filter material of filtered particles. In one non-limiting configuration, the filter flushing arrangement includes one or more sprayers that are located in the interior of the filter drum and are configured to spray liquid towards the side of the filter drum to cause materials lodged in the filter material on the outer surface of the filter material to become dislodged from the filter material. In one non-limiting arrangement, the filter drum is configured to rotate and the filter flushing arrangement is configured to remain stationary such as the filter drum rotates sprayed liquid from the filter flushing arrangement is applied to nearly or all of inner surface of the filter drum to effectively remove material from the outer surface of the filter material. In another non-limiting embodiment, the filter arrangement optionally includes one or more monitors or sensors to a) monitor flow rates into and/or out of the filter arrangement to i) determine if proper rates of filtering are occurring by the filter arrangement, ii) determine if the filter material is being properly cleaned so as to increase/decrease liquid flush flows (e.g., increase/decrease liquid flow through the spray bar) for filter material cleaning, and/or iii) determine if filter material needs to be cleaned or replaced; and/or b) monitor particle size of materials in the liquid exiting the filter arrangement to determine if the filter material is damaged and thereby allowing too large of particles to remain in the cleaned liquid.

In another and/or alternative non-limiting aspect of the disclosure, the disclosed systems, devices, and methods can provide one or more of the following advantages over the prior art: (i) eliminate or greatly reduce chips/fines floating in an intermediate space (e.g., intermediate conveyor area, etc.); (ii) easier serviceability of wear parts based on the system's configuration; (iii) allow for two or more conveyor systems to be flush with one another; (iv) allow for two or more conveyor systems to be any height in relation to one another, thereby allowing for lower profile applications; (v) eliminate mating flanges of conveyor systems for ease of manufacturability; (vi) providing a drum that has less components and/or requires less machining, welding, and assembly; (vii) providing a drum seal assembly that is formed of ultra-high molecular weight polyethylene that increases the durability of the drum and/or reduces the maintenance required; and/or (viii) providing a retractable cleat system that allows for higher chip carrying loads.

One non-limiting object of the present disclosure is the provision of a conveyor device that improves the ease, efficiency and/or effectiveness in separating chippings/fines and cooling liquid.

In another and/or alternative non-limiting object of the present disclosure is the provision of a conveyor device that addresses floating chip/fines issues in the intermediate conveyor area (e.g., area located between the upper and lower runs, or the upper run of the conveyor belt and the upper surface of the bottom of the frame of the conveyor system).

In another and/or alternative non-limiting object of the present disclosure is the provision of a conveyor device that addresses floating chip/fines issues in the intermediate conveyor area while handling higher liquid volumes deposited or feed to the conveyor device.

In another and/or alternative non-limiting object of the present disclosure is the provision of a conveyor device that improves the ease and convenience of serviceability of the conveyor devices and the apparatuses used therewith.

In another and/or alternative non-limiting object of the present disclosure is the provision of a conveyor device that requires less and/or easier maintenance, while providing longer longevity to the conveyor devices and the apparatuses.

In another and/or alternative non-limiting object of the present disclosure is the provision of a conveyor device that eliminates or greatly reduces chips/fines floating in the intermediate conveyor area.

In another and/or alternative non-limiting object of the present disclosure is the provision of a conveyor device that optionally allows for two or more conveyor systems to be flush with one another during operation.

In another and/or alternative non-limiting object of the present disclosure is the provision of a conveyor device that optionally allows for two or more conveyor systems to be any height in relation to one another, thereby allowing for lower profile applications.

In another and/or alternative non-limiting object of the present disclosure is the provision of a conveyor device that optionally eliminates mating flanges of conveyor systems for ease of manufacturability.

In another and/or alternative non-limiting object of the present disclosure is the provision of a conveyor device that optionally includes a filter drum that has less components and/or requires less machining, welding, and assembly.

In another and/or alternative non-limiting object of the present disclosure is the provision of a conveyor device that optionally includes a drum seal assembly that is formed of ultra-high molecular weight polyethylene that increases the durability of the drum and/or reduces the maintenance required.

In another and/or alternative non-limiting object of the present disclosure is the provision of a conveyor device that optionally includes a retractable cleat system that allows for higher chip carrying loads.

In another and/or alternative non-limiting object of the present disclosure is the provision of a conveyor device that is optionally configured to a) aid in directing the pourable solid and liquid materials that are located in an intermediate conveyor area to be properly processed, b) process higher volumes of metal chips, scrap, etc. to the desired discharge location, and/or c) provides easier access to filter wear parts on the device.

In another and/or alternative non-limiting object of the present disclosure is the provision of a conveyor device that includes one or more flume/trough systems that are configured to receive a flow of liquid and solid materials from a) an intermediate conveyor area between the upper and lower runs of the conveyor belt or the upper run of the conveyor belt and the upper surface of the bottom of the frame of the conveyor system, and/or b) other locations on and/or about the upper and lower runs of the conveyor belt.

In another and/or alternative non-limiting object of the present disclosure is the provision of a conveyor device that includes one or more flume/trough systems having one or more of the following features a) one or more enclosed troughs that directs liquids and solids to a particular location (e.g., toward a filter drum, etc.); b) one or more sloped troughs that facilitates in directing liquids and solids to a particular location (e.g., toward a filter drum, etc.); c) one or more openings in the frame to enable liquid flow and particle flow from the intermediate conveyor area and into the one or more troughs; d) a flushing arrangement that is configured to add fluid to the one or more troughs so as to facilitate in maintaining certain liquid volumes and/or flow rates in the one or more troughs to thereby facilitate in directing liquids and solids to a particular location (e.g., toward a filter drum, etc.); e) one or more level monitors and/or sensors to monitor fluid levels in the one or more troughs which can be used to i) cause additional fluid to be added to the one or more troughs to maintain certain liquid volumes and/or flow rates in the one or more troughs, and/or ii) to increase or decrease the volume of liquid and solid materials added to the separation device so to I) prevent overloading and/or causing overflowing of fluid and material from the one or more troughs, II) prevent fully filling and/or causing an overflow in the intermediate conveyor area between the upper and lower runs of the conveyor belt by the fluid and material, and/or III) prevent starving or unacceptable low flow rates in the one or more troughs; and/or f) a wide feed opening into a filter arrangement (e.g., filter drum, etc.) to accommodate large fluid flow rates and to assure proper and desired flow rate of the liquid into the filter arrangement.

In another and/or alternative non-limiting object of the present disclosure is the provision of a conveyor device that optionally includes one or more retractable cleat systems.

In another and/or alternative non-limiting object of the present disclosure is the provision of a conveyor device that optionally includes one or more retractable cleat systems that be an extension of standard bar cleats or a separate structure from a standard bar cleat, and wherein the retractable cleat systems are positioned in predetermined distances along the entirety of conveyor belt assemblies and are configured/designed to help carry bulk materials a certain distance to a discharge or material handling process.

In another and/or alternative non-limiting object of the present disclosure is the provision of a conveyor device that optionally includes one or more retractable cleat systems that includes a spring or other biasing arrangement and/or a hinge mechanism to enable the retractable cleat to move between a retracted position and a raised position.

In another and/or alternative non-limiting object of the present disclosure is the provision of a conveyor device that includes one or more retractable cleat systems and wherein the frame of the conveyor and/or the optionally retractable cleat includes one or more features to enable the raising and retracting of the retractable cleat.

In another and/or alternative non-limiting object of the present disclosure is the provision of a conveyor device that optionally includes one or more retractable cleat systems that have a tooth configuration and/or other non-constant linear shape along the width of the retractable cleat to facilitate in grabbing materials on the upper run of the upper conveyor so that such material can be effectively and efficiently conveyed away by the upper conveyor.

In another and/or alternative non-limiting object of the present disclosure is the provision of a conveyor device that optionally include one or more filter arrangements to filter and/or separate material from the liquid.

In another and/or alternative non-limiting object of the present disclosure is the provision of a conveyor device wherein the filter arrangement optionally includes a rotating filter drum and a filter material connected to the inside and/or outside surface of the filter drum.

In another and/or alternative non-limiting object of the present disclosure is the provision of a conveyor device wherein the filter arrangement optionally includes a filter flushing arrangement that applies (e.g., sprays. etc.) liquid on/to the filter material to partially or fully clean the filter material of filtered particles.

In another and/or alternative non-limiting object of the present disclosure is the provision of a conveyor device wherein the filter arrangement optionally includes one or more monitors or sensors to a) monitor flow rates into and/or out of the filter arrangement to i) if proper rates of filter are occurring, ii) determine if filter material is being properly cleaned so as to increase/decrease liquid flush flows for filter material cleaning, and/or iii) determine if filter material needs to be cleaned or replaced, and/or b) monitor particle size of materials in the liquid exiting the filter arrangement to determine if filter material is damaged and allowing too large of particle to remain in cleaned liquid.

In another and/or alternative non-limiting object of the present disclosure is the provision of a conveyor device wherein the filter arrangement optionally includes a filter system that includes a frame (e.g., cylindrical shaped frame, etc.) and a filter medium that is connected to the frame.

In another and/or alternative non-limiting object of the present disclosure is the provision of a conveyor device wherein the filter arrangement optionally includes one or more filter systems, one or more seals, and other wear internal parts that are configured to be accessible from the external sides of the conveyor.

In another and/or alternative non-limiting object of the present disclosure is the provision of a conveyor device wherein the filter arrangement optionally includes one or more removable outer caps, one or more bearings, and/or one or more seals that enable a user to remove the one or more removable outer caps, one or more bearings, and/or one or more seals to easily access and service and/or inspect the filter drum without having to disassemble the conveyor belts.

In another and/or alternative non-limiting object of the present disclosure is the provision of a conveyor device wherein the filter arrangement optionally includes outer drum seal assemblies that can optionally be bolted to the outside of the conveyor frame to provide for quick and easy access to the filter arrangement components to able seal replacement and other internal wear parts, thereby significantly decrease labor time and increase uptime of operations (e.g., to facilitate in the cleaning, removal, and/or replacement of the filter, the filter drum, the seals, and/or other components, etc.).

In another and/or alternative non-limiting object of the present disclosure is the provision of a conveyor device wherein the filter arrangement optionally includes a filter drum that can be optionally rotated by a motor, and/or engagement with one or both of the conveyor belts.

In another and/or alternative non-limiting object of the present disclosure is the provision of a conveyor device wherein the filter arrangement optionally includes a filter flushing arrangement that applies (e.g., sprays. etc.) liquid on/to the filter material to partially or fully clean the filter material of filtered particles.

In another and/or alternative non-limiting object of the present disclosure is the provision of a conveyor device wherein the filter arrangement optionally includes a filter flushing arrangement includes one or more sprayers that are located in the interior of the filter drum and are configured to spray liquid towards the side of the filter drum to cause materials lodged in the filter material on the outer surface of the filter material to become dislodged from the filter material.

In another and/or alternative non-limiting object of the present disclosure is the provision of a conveyor system for processing a pourable conveying material; and wherein the conveyor system comprising: a) a first conveyor; the first conveyor includes a first frame and a first endless belt having a first upper run and a first lower run; the first frame at least partially supports the first endless belt; the first conveyor is configured to convey at least a portion of the conveying material in a first conveying direction; the first endless belt is configured to enable at least a portion of liquid in the conveying material to pass through the first endless belt; b) a second conveyor; the second conveyor includes second frame and a second endless belt having a second upper run and a second lower run; the second frame at least partially supports the second endless belt; the second conveyor is configured to convey at least a portion of the conveying material in a second conveying direction; the second endless belt is configured to enable at least a portion of liquid in the conveying material to pass through the second endless belt; c) an intermediate conveyor area that is configured to receive at least a portion of the conveying material; the intermediate conveyor area at least partially defined as a region between the first upper run of the first conveyor and the second lower run of the second conveyor; the intermediate conveyor area includes a base that is positioned under the second lower run of the second conveyor and one or more side walls; the intermediate conveyor area includes one or more side openings in the one or more side walls; and d) a trough system; the trough system is configured to receive at least a portion of the conveying material that passes from the intermediate conveyor area through the one or more side openings in the intermediate conveyor area; the trough system is configured to convey the conveying material that enters the trough system to a storage facility or filter system.

In another and/or alternative non-limiting object of the present disclosure is the provision of a conveyor system for processing a pourable conveying material wherein the trough system includes a first trough that is connected to one of the side walls of the intermediate conveyor area.

In another and/or alternative non-limiting object of the present disclosure is the provision of a conveyor system for processing a pourable conveying wherein the trough system has a sloped bottom surface used to facilitated in the flow of material towards the storage facility or the filter system.

In another and/or alternative non-limiting object of the present disclosure is the provision of a conveyor system for processing a pourable conveying material wherein the trough system includes fluid connector arrangement that is configured to connect to a secondary liquid source to be connected to the trough system so as to add liquid to the trough system.

In another and/or alternative non-limiting object of the present disclosure is the provision of a conveyor system for processing a pourable conveying material wherein the trough system includes a first sensor arrangement; the first sensor arrangement is configured to monitor liquid levels in the trough system and/or fluid flow rates in the trough system.

In another and/or alternative non-limiting object of the present disclosure is the provision of a conveyor system for processing a pourable conveying material wherein the first sensor arrangement provides information to a control system, and wherein the control system is configured to i) cause additional liquid to be added to the trough system to maintain certain liquid volumes and/or flow rates in the trough system, and/or ii) increase or decrease a volume of the pourable conveying material added to the conveyor system so to I) inhibit or prevent overloading and/or causing overflowing of fluid and material from the trough system, II) prevent fully filling and/or causing an overflow the intermediate conveyor area, and/or III) inhibit or prevent starving or unacceptable low flow rates or low volumes of liquid in the trough system.

In another and/or alternative non-limiting object of the present disclosure is the provision of a conveyor system for processing a pourable conveying material wherein the first trough includes one or more walls to form an enclosure for the liquid in the first trough to inhibit or prevent the conveying material in the trough from flowing out the trough until the conveying material exits at fluid exit of the first trough.

In another and/or alternative non-limiting object of the present disclosure is the provision of a conveyor system for processing a pourable conveying material further including a filter system; the filter system fluidly connected to the trough system to receive at least a portion of the conveying material from the trough system.

In another and/or alternative non-limiting object of the present disclosure is the provision of a conveyor system for processing a pourable conveying material wherein the trough system includes a fluid exit that is connected to the filter system; the fluid exit has a width that is at least 90% of a width of a cavity of the filter system.

In another and/or alternative non-limiting object of the present disclosure is the provision of a conveyor system for processing a pourable conveying material wherein the filter system includes a rotatable filter drum and a filter flushing arrangement; the rotatable filter drum is configured to rotate about a longitudinal axis of the rotatable filter drum; the rotatable filter drum includes a drum frame and a filter material; the filter material formed on and/or connected to the drum frame; the filter flushing arrangement is configured to direct a fluid toward the rotatable filter drum to cause materials from the conveying material that are adhering to the drum filter to be removed from the rotatable filter drum.

In another and/or alternative non-limiting object of the present disclosure is the provision of a conveyor system for processing a pourable conveying material wherein the filter flushing arrangement is configured to remain stationary while the rotatable filter drum rotates about the longitudinal axis of the rotatable filter drum.

In another and/or alternative non-limiting object of the present disclosure is the provision of a conveyor system for processing a pourable conveying material wherein the filter system includes one or more removable outer caps, one or more removable bearings, and/or one or more removable seals that are accessible from an exterior side of the first and/or second conveyors to enable a user to remove the one or more removable outer caps, the one or more bearings, and/or the one or more seals to access and remove the drum filter without having to disassemble the first and/or second endless belts.

In another and/or alternative non-limiting object of the present disclosure is the provision of a conveyor system for processing a pourable conveying material wherein the rotatable filter drum engages a portion of the second endless belt; movement of the second endless belt is configured to cause the rotatable filter drum to rotate about a longitudinal axis of the rotatable filter drum.

In another and/or alternative non-limiting object of the present disclosure is the provision of a conveyor system for processing a pourable conveying material wherein the filter system includes one or more monitors or sensors; the one or more monitors or sensors are configured to perform one or more functions selected from the group consisting of a) monitoring flow rates into and/or out of the filter system to i) determine if proper rates of filtering are occurring by the filter system, ii) determine if a filter material in the filter system is being properly cleaned and to cause adjustments in liquid flush flows based on such information, and/or iii) determining if the filter material needs to be cleaned or replaced; and/or b) monitoring particle size of materials in liquid exiting the filter system to determine if the filter material is damaged and/or not properly filter the material.

In another and/or alternative non-limiting object of the present disclosure is the provision of a conveyor system for processing a pourable conveying material wherein the first endless belt includes one or more retractable cleat systems; each of the retractable cleat system includes a base cleat portion that is connected to the first endless belt, and upper cleat portion, and a biasing and/or hinge arrangement that is connected to the base cleat portion and the upper cleat portion and is configured to enable the upper cleat portion to move between a retracted position and a raised position; a maximum height of the upper cleat portion from a top surface of the first endless belt in the raised position is greater than a maximum height of the upper cleat portion from a top surface of the first endless belt in the retracted position.

In another and/or alternative non-limiting object of the present disclosure is the provision of a conveyor system for processing a pourable conveying material wherein the upper cleat portion includes a roller to facilitate in movement of the retractable cleat system when the upper cleat portion is in the retracted position.

In another and/or alternative non-limiting object of the present disclosure is the provision of a conveyor system for processing a pourable conveying material wherein the first frame of the first conveyor includes one or more engagement structures that are configured to engage a portion of the upper cleat portion to cause the upper cleat portion to move from the raised position to the retracted position as the retractable cleat moves between the first upper run to the first lower run.

In another and/or alternative non-limiting object of the present disclosure is the provision of a conveyor system for processing a pourable conveying material wherein the upper cleat portion of one or more of the retractable cleat systems includes a tooth configuration and/or other non-constant linear shape along a width of the retractable cleat.

In another and/or alternative non-limiting object of the present disclosure is the provision of a method for separating solid materials from a pourable liquid and solid material mixture comprising: a) providing a conveyor system; the conveyor system comprising: A) a first conveyor; the first conveyor includes a first frame and a first endless belt having a first upper run and a first lower run; the first frame at least partially supports the first endless belt; the first conveyor is configured to convey at least a portion of the conveying material in a first conveying direction; the first endless belt configured to enable at least a portion of liquid in the conveying material to pass through the first endless belt; B) a second conveyor; the second conveyor includes second frame and a second endless belt having a second upper run and a second lower run; the second frame at least partially supports the second endless belt; the second conveyor is configured to convey at least a portion of the conveying material in a second conveying direction; the second endless belt configured to enable at least a portion of liquid in the conveying material to pass through the second endless belt; C) an intermediate conveyor area that is configured to receive at least a portion of the conveying material; the intermediate conveyor area at least partially defined as a region between the first upper run of the first conveyor and the second lower run of the second conveyor; the intermediate conveyor area includes a base that is positioned under the second lower run of the second conveyor and one or more side walls; the intermediate conveyor area includes one or more side openings in the one or more side walls; and D) a trough system; the trough system configured to receive at least a portion of the conveying material that pass from the intermediate conveyor area through the one or more side openings in the intermediate conveyor area; the trough system is configured to convey the conveying material that enters the trough system to a storage facility or filter system; b) pouring the pourable liquid and solid material mixture onto at least a portion of the upper run of the first endless belt of the first conveyor; c) operating the first conveyor to cause the upper run to move larger solid materials to a first material discharge for the first conveyor; d) enabling liquid and smaller solid materials to pass about and/or through the first endless belt and to flow into the intermediate conveyor area; f) enabling the liquid and smaller solid materials in the intermediate conveyor area to flow through the one or more side openings and into the trough system; and g) directing a flow of the liquid and smaller solid materials in the trough system to the to a storage facility or to the filter system.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 depicts a non-limiting material separating system in accordance with the present disclosure comprising a first conveyor system and a second conveyor system, wherein the first and second conveyor systems are configured to define an intermediate conveyor area therebetween;

FIG. 2 is a first side view of an exemplary, non-limiting material separating system in accordance with the present disclosure illustrating an exemplary direction of belt travel and material flow of the first and second conveyor systems;

FIG. 3 is an enlarged second side view of the material separating system of FIG. 2 illustrating an exemplary flume/trough system positioned on the second side of the system;

FIG. 4 depicts a detailed view of the flume/trough system of FIG. 3;

FIG. 5 is a perspective view of another non-limiting exemplary flume/trough system configured for use with the overall material separating system of FIGS. 1 and 2;

FIG. 6 is enlarged perspective view of the flume/trough system and of FIG. 5;

FIG. 7 is still another perspective view of the flume/trough system of FIG. 5;

FIG. 8A is a detailed side view of an exemplary retractable cleat system on a portion of the belt of the first conveyor system that can be used with the overall material separating system of FIGS. 1 and 2 wherein is the retractable cleat is in the raised position;

FIG. 8B is a detailed side view of an exemplary retractable cleat system on a portion of the belt of the first conveyor system that can be used with the overall material separating system of FIGS. 1 and 2 wherein is the retractable cleat is in the retracted position;

FIG. 9A is a perspective view of front side the retractable cleat system of FIG. 8A;

FIG. 9B is a perspective view of rear side the retractable cleat system of FIG. 8B;

FIG. 10A is a side view of the retractable cleat system of FIG. 8A illustrating the increased surface area as compared to normal surface area created with conventional cleats;

FIG. 10B is a side view of the retractable cleat system of FIG. 8A illustrating the increased surface area as compared to normal surface area created with conventional cleats;

FIG. 11A depicts another non-limiting exemplary retractable cleat system that may be configured for use with the overall system of FIG. 2 wherein the top edge of the retractable cleat includes a jagged edge or saw edge that is used to facilitated in grabbing materials;

FIG. 11B is an enlarged side view of a portion of the first conveyor system of the material separating and illustrates the interaction between the retractable cleat and frame of the first conveyor system to cause the retractable cleat to move form the raised to the retract position;

FIG. 12 is a cross-sectional view of a non-limiting exemplary filter system that may be configured for use with the overall material separating system of FIGS. 1 and 2;

FIG. 13 depicts an exemplary drum cage of the filter system of FIG. 12;

FIG. 14 is an enlarged portion of the material separating system of FIGS. 1 and 2 and illustrates a partially exploded view of the filter system of FIG. 12;

FIG. 15 depicts an exemplary, non-limiting bearing being removed from the filter system of FIG. 12;

FIG. 16 depicts an exemplary, non-limiting gasket seal that is configured for use with the bearing of FIG. 15;

FIG. 17 is another perspective rear view of a portion of the material separating system of FIGS. 1 and 2 and illustrating portions the filter system and external components of FIG. 14 in an exploded orientation;

FIG. 18 is another non-limiting material separating system in accordance with the present disclosure comprising a first conveyor system and a second conveyor system, wherein the first and second conveyor systems are configured to define an intermediate conveyor area therebetween;

FIG. 19 is an enlarged rear perspective view of a bottom portion of the material separating system that illustrates a wide flow region of the fluid flowing in the exemplary flume/trough system and into the filter system;

FIG. 20 is an enlarged sectional rear perspective view of a bottom portion of the material separating system that illustrates a wide flow region of the fluid flowing in the exemplary flume/trough system and into the filter system;

FIG. 21 is an enlarged side view of a bottom portion of the material separating system that illustrates a fluid level sensor in the exemplary flume/trough system and into the filter system and a liquid flush connector in the exemplary flume/trough system used to add additional fluid to the exemplary flume/trough system;

FIG. 22 is a rear perspective view of the material separating system that illustrates a wide flow region of the fluid flowing in the exemplary flume/trough system and into the filter system; and

FIG. 23 is an enlarged sectional rear perspective view of a bottom portion of the material separating system that illustrates a fluid level sensor in the exemplary flume/trough system and into the filter system and a liquid flush connector in the exemplary flume/trough system used to add additional fluid to the exemplary flume/trough system.

### DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values and ranges therebetween).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not illustrate the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

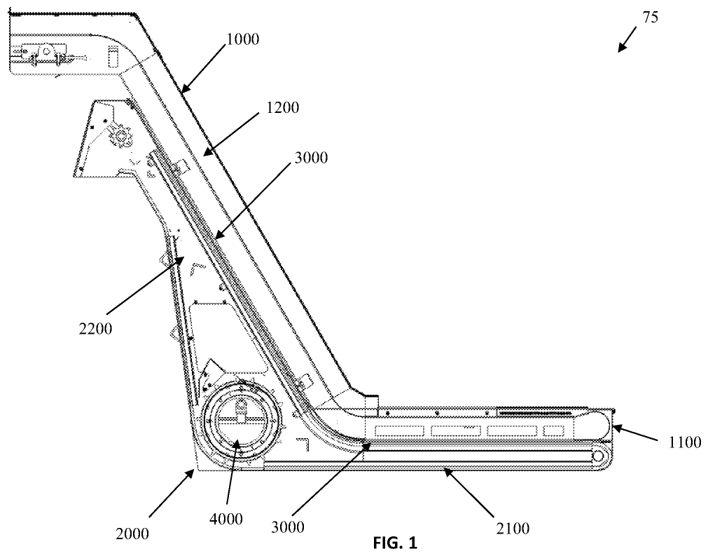

FIG. 1 depicts a material separating system 75 that includes a first conveyor system and a second conveyor system, wherein the first and second conveyor systems are configured to define an intermediate conveyor area 22 therebetween. Additional details regarding such a conveyor system are illustrated in U.S. Pat. Nos. 7,115,200; 7,485,226; 7,563,369; 7,648,632; 10,994,936; 7,014,760; and 7,014,764, and U.S. Patent Publication No. 2010/0012564, which are incorporated fully herein by reference.

With reference to FIG. 1, a material separating system 75 in the form of a chip separating system is provided that comprises a first conveyor system 1000 and a second conveyor system 2000. The first conveyor system 1000 includes a horizontal piece 1100 and an ascending piece 1200. The second conveyor system 2000 includes a horizontal piece 2100 and an ascending piece 2200. The first conveyor system 1000 sits on and/or is positioned above the second conveyor system 2000 such that the horizontal piece 1100 is substantially parallel to the horizontal piece 2100, and the ascending piece 1200 is substantially parallel to the ascending piece 2200; however, this is not required. When first conveyor system 1000 sits on or is positioned above the second conveyor system 2000, an intermediate conveyor area or intermediate conveyor area 3000 is formed between the first and second conveyor systems (i.e., between the horizontal pieces 1100, 2100 and between the ascending pieces 1200, 2200. The first conveyor system 1000 is configured to separate larger chippings and/or material pieces from a liquid/material mixture 20 that is deposited on the top surface of a portion of the first conveyor system 1000, and the second conveyor system 2000 is configured to advance the smaller pieces of chippings and/or material pieces and the liquid that passed through the first conveyor system 1000 and entered into the intermediate conveyor area 3000 to a filter drum 4000 so that the smaller pieces of chippings and/or material pieces can be separated from the liquid to form a cleaned liquid stream. The filter drum 4000 includes components that are configured to separate the smaller chippings/fines from the liquid so that the liquid can be reused in other material processing systems and/or used in the material separating system 75. The larger pieces of chippings and/or material pieces that are conveyed by the first conveyor system 1000 and the smaller pieces of chippings and/or material pieces that are conveyed by the second conveyor system 2000 can be deposited in receptacles or bins for recycling or further processing.

The disclosed systems, devices, and methods provide endless belt conveyors that enable solid and liquid mixtures to efficiently and effectively removed from the intermediate conveyor area 3000, enable large volumes of the solid and liquid mixture to be processed by the first and second conveyor systems 1000 and 2000 removed from the intermediate conveyor area 3000 and further filtered, to improved the removal of larger volumes of material from the first conveyor system 1000, and to provide improved access to wear parts among the filter system 4000.

In one optional configuration of the disclosed systems, devices, and methods, horizontal piece 2100 of second conveyor system 2000 is optionally removed, thereby eliminating the intermediate conveyor area 3000 formed between the horizontal pieces 1100, 2100 and eliminating floating material between such intermediate conveyor area 3000.

In one or more non-limiting implementations of the present disclosure, the disclosed systems, devices, and methods are configured to include one or more flume/trough systems that are configured to direct the flow of liquid and solid materials from the intermediate conveyor area formed between the upper and lower runs of the conveyor belt to a filtering system that is used to separate all or a portion (e.g., 20-99% and all values and ranges therebetween) of the solid materials from the liquid, and wherein the cleaned liquid can be used in further processes of the material separating system 75, used in other machining processes, etc., and the separated solid materials can be conveyed to a bin or receptacle for further processing (e.g., recycling, disposal, etc.). As can be appreciated, a portion or all of the liquid and solid materials from the intermediate conveyor area can be conveyed by the one or more flume/trough systems to other systems (e.g., filtering conveyor, external filter, other material handling process, etc.).

In one or more non-limiting implementations, the one or more modular flume/trough systems includes a structure (e.g., trough, etc.) that receives liquid and solid materials from one or more frame opening slots located in the intermediate conveyor area.

In one or more non-limiting implementations, the one or more modular flume/trough systems optionally function as a gateway for pourable solid and liquid material to provide a constant flow of material from the intermediate conveyor area to a filter system (e.g., filter drum, etc.).

In one or more non-limiting implementations, the one or more modular flume/trough systems optionally has a bolted design/configuration that provides flexibility to increase the height, length, and/or width of the one or more modular flume/trough systems so that the one or more modular flume/trough systems can be integrated with various conveyor designs, types, and sizes. The modular design of the one or more modular flume/trough systems advantageously can optionally allow for maintenance access points and adjustments for effective operation. The one or more modular flume/trough systems can act as a pathway for liquid and solid materials to facilitate in alleviating material buildup and floating chips in the intermediate conveyor area 3000, thereby improving machine production uptime by eliminating spaces for material to accumulate or cause jamming in the material separating system 75.

In one or more non-limiting implementations, the disclosed systems, devices, and methods can optionally be configured to include one or more retractable cleat systems. The one or more retractable cleat systems, when used, can optionally be an extension of standard bar cleats which are positioned in predetermined distances along the entirety of conveyor belt assemblies which are designed to help carry bulk materials a certain distance to a discharge or material handling process. As can be appreciated, the one or more retractable cleat systems can be separate cleats from the standard bar cleats on the belt. As can be appreciated, the belt can include a) only standard cleats, b) both standard cleats and retractable cleats, or c) only retractable cleats. The proper number and height of cleats may vary depending on the application (type of materials being moved, volume, etc.). The cleat height may have certain limitations based on conveyor framing footprints.

In one or more non-limiting implementations, the one or more retractable cleat systems includes a spring or other type of biasing arrangement and/or hinge mechanism to enable each of the retractable cleats to move between the retracted position and a raised position as the retractable cleats move on the belt of the conveyor. The retractable cleat can be configured to extend upwardly from the top surface of the conveyor belt to a height that is higher-than-normal size cleats, thereby increasing surface area and allowing for more materials to be grabbed and carried out to the discharge area, thereby reducing the chances of overflow and unexpected maintenance repairs.

In one or more non-limiting implementations, the one or more retractable cleat systems, when used, are configured to transition between the retracted and raised positions as the conveyor belt transitions from the lower to the upper run. In one non-limiting configuration, the one or more retractable cleat systems are configured to be in the raised position as the retractable cleats move on the upper run of the first conveyor system 1000, and transition to the retracted position at the end of the upper run and remain in the retracted position during the lower run, and then transition from the retracted to the raised position at the end of the lower run. This process of retracing and raising repeats along the endless conveyor belt so that larger amounts of material can be carried and discharged from the first conveyor system 1000, and the retraction of the one or more retractable cleat systems as the one or more retractable cleat systems move along the lower run of the first conveyor system 1000 allow the spacing between the first conveyor system 1000 and the second conveyor system 2000 to be minimized. In many operations with heavy metal cutting applications, without proper means to carry out excess material from the upper run of the first conveyor system 1000, operators often experience a “tumble back” on the upper run which can prevent such solid material from being properly carried to the discharge point. Expanding the area that the cleat can grab and retrain material as the material is moved along the upper run of the first conveyor system 1000 helps to alleviate chip and material buildup and accumulation on the upper run of the first conveyor system 1000, and better maintains operating conditions free of debris and minimize jamming during the operation of the material separating system 75.

In one or more non-limiting implementations, the disclosed systems, devices, and methods can optionally include one or more filter systems. In one non-limiting embodiment, the one or more filter systems can optionally include seals and other wear internal parts that are accessible from the external sides of the material separating system 75. In one non-limiting configuration, the one or more filter systems optionally include one or more outer caps, one or more bearings, and/or one or more seals. The one or more outer caps, one or more bearings, and/or one or more seals may be formed of ultra-high molecular weight polyethylene (UHIW) material, hardened steel, other materials with imprinted grooves, or combinations thereof; however, other materials can be used (e.g., metal, composite materials, ceramic, etc.). In another non-limiting configuration, the outer drum seal assemblies can optionally be bolted to the outside of the conveyor frame of the material separating system 75. In another non-limiting configuration, when maintenance of the filter system is required, fittings such as screws, nuts, bolts, or other, can be quickly disconnected to provide access to the seals, bearings, filter drum frame, filter material, etc. for replacement and/or repair, thereby significantly decreasing labor time and increase uptime of operations of the material separating system 75. During normal operating conditions, extensive labor and time is needed to disassemble major components to gain access to the filter system. In most cases, replacing components of the filter system can take an extensive amount of time, thereby resulting in production time being significantly lost. The filter system in accordance with the present disclosure decreases labor time (to a fraction of the time) to replace critical components alleviating extensive downtime and production among machine operators.

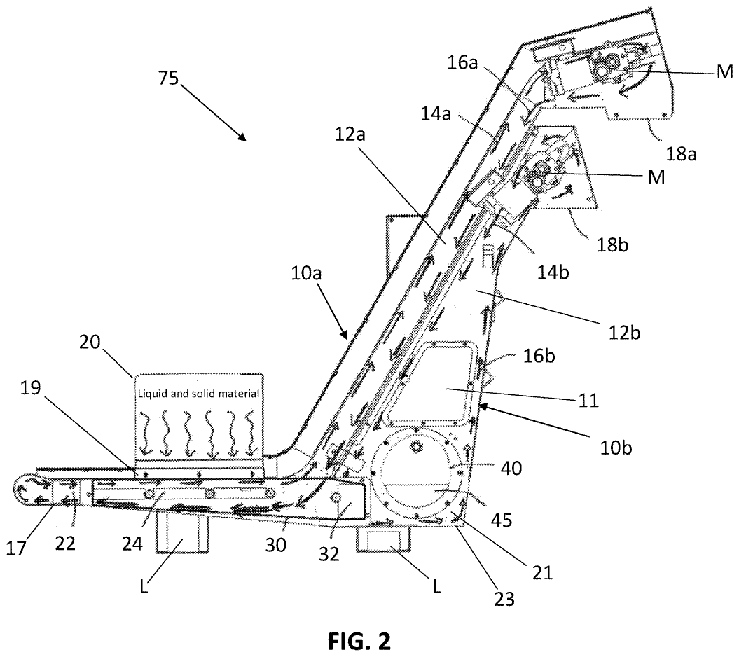

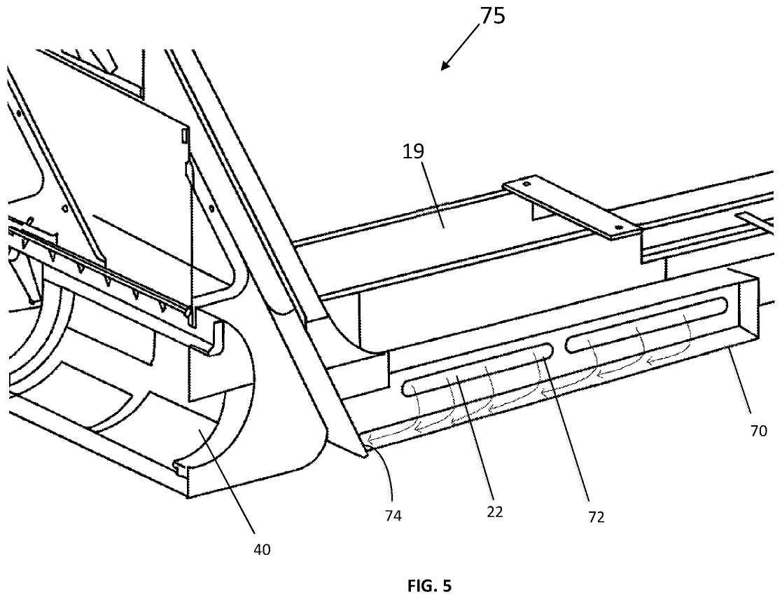

Referring now to FIG. 2, a first side view of an exemplary, non-limiting material separating system 75 in accordance with the present disclosure illustrating an exemplary direction of belt travel and material flow. The material separating system 75 includes a first conveyor system 10a and a second conveyor system 10b. First conveyor system 10a includes conveyor belt 12a, upper run 14a, lower run 16a, and discharge 18a. Second conveyor system 10b includes conveyor belt 12b, upper run 14b, lower run 16b, and discharge 18b. The material discharged from discharges 18a, 18b can be into a container, onto another conveyor, etc. As illustrated, the frames of first conveyor system 10a and second conveyor system 10b are flush with one another; however, this is not required. During operation of material separating system 75, liquid and/or solid materials 20 falls onto an upper run 14a of conveyor belt 12a. As best illustrated in FIG. 5, a material receiving bin 19 can optionally be used to facilitate in directing liquid and/or solid materials 20 falls onto upper run 14a of conveyor belt 12a. The configuration of the material receiving bin 19 is non-limiting. The manner in which the liquid and/or solid materials 20 falls onto upper run 14a of conveyor belt 12a is non-limiting. One or more motors M can be used to drive the movement of the conveyor belts. The operation of the belts, the standard components of the belts and how the motors drive the belts are well know in the art and will not be described herein. The Second conveyor system 10b can optionally be elevated above a ground surface one or more legs L; however, other structures can be used.

After the liquid and/or solid materials 20 is deposited onto upper run 14a of conveyor belt 12a, the larger solid materials in the liquid and/or solid materials 20 are carried along the conveyor belt 12a from left to right towards discharge 18a. It is to be appreciated that the conveyor belt 12a can move from right to left. Most or all of the liquid and some or all of the small particles of the liquid and/or solid materials 20 pass through the upper run 14a of conveyor belt 12a and enter the intermediate conveyor area 22, which is an area located between the upper run 14a and lower run 16a, or the space between the upper run 14a and the upper surface 17 of frame 15. The liquid and small particles that pass into intermediate conveyor area 22 proceed to flow out of intermediate conveyor area 22 via one or more frame slots 24 and into a flume/trough system 30. The velocity of liquid flowing in the flume/trough system 30 causes the materials in the liquid to flow from left to right through the flume/trough system 30 and then be discharge through trough opening 32. The liquid and materials that exit through trough opening 32 then flow into an external source (e.g., a conveyor, filter, recycling bin, other material handling source, etc.). In the present non-limiting embodiment, the trough opening 32 exits into a drum assembly 40 in the second conveyor system 10b. Drum assembly 40 can include a filter. Liquid and solid particles that flow into the drum assembly 40 are pushed towards the filter which filters most or all of the materials in the liquid from the liquid so as to produce a clean liquid stream. The clean liquid streams then flows out of the drum assembly via fluid opening 45. In one or more implementations, the drum assembly 40 and/or filter is externally secured by mechanical fasteners (bolts, screw, etc.). Any small particulates that settles to the bottom of the drum assembly 40 are carried by lower run 16b up and out the discharge 18b as the lower run 16b transitions to upper run 14b. The upper portion of the second conveyor system 10b can optionally include a window 11 that enables a user to view the operation of the drum assembly 40 to determine is proper operation is occurring or servicing is required.

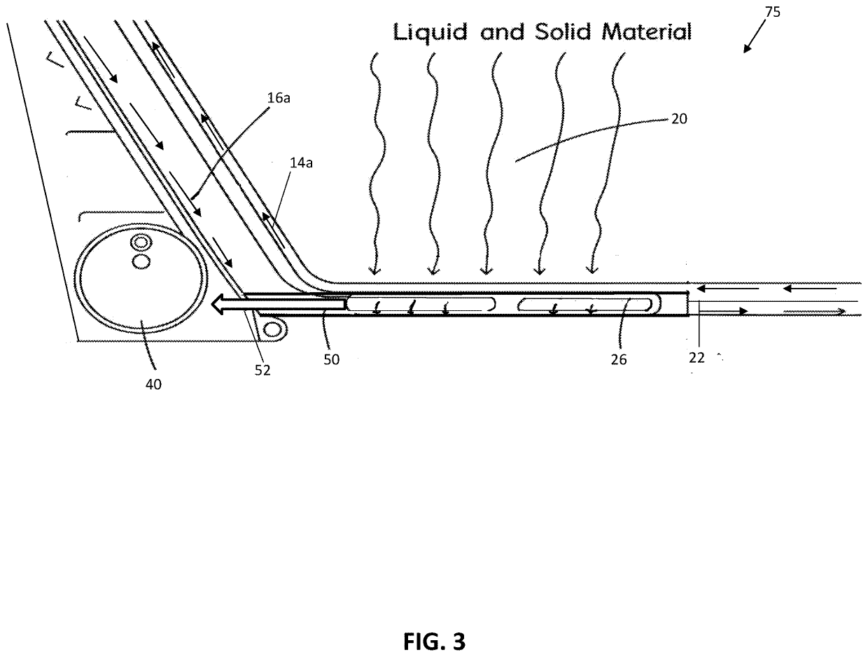

Referring now to FIG. 3, there is illustrated a second side view of the non-limiting material separating system 75 having a flume/trough system 50 disposed on the second side of the material separating system 75. As can be appreciated, flume/trough system 50 is optional and material separating system 75 can only include a flume/trough system on one side of material separating system 75. The flume/trough system 50 can optionally include the same components and function the same as that of the flume/trough system 30; however, this is not required. The size and/or shape of flume/trough system 50 can be the same as flume/trough system 30; however, this is not required. During operation of material separating system 75, the liquid and/or solid materials 20 move along the upper run 14a of conveyor belt 12a towards discharge 18a. The liquids and solid materials that are not discharged by upper run 14a travel into the intermediate conveyor area 22. The liquids and solid materials that move to the intermediate conveyor area 22 are discharged through frame slot holes 26 (similar to frame slots 24) and into the flume/trough system 50. The velocity of liquid flowing in the flume/trough system 50 causes the materials in the liquid to flow from right to left through the flume/trough system 50 and then be discharged through trough opening 52. The liquid and materials that exit through trough opening 52 then flow into an external source (e.g., a conveyor, filter, recycling bin, other material handling source, etc.). In the present non-limiting embodiment, the trough opening 52 exits into a drum assembly 40 in the second conveyor system 10b for further filtration and material management.

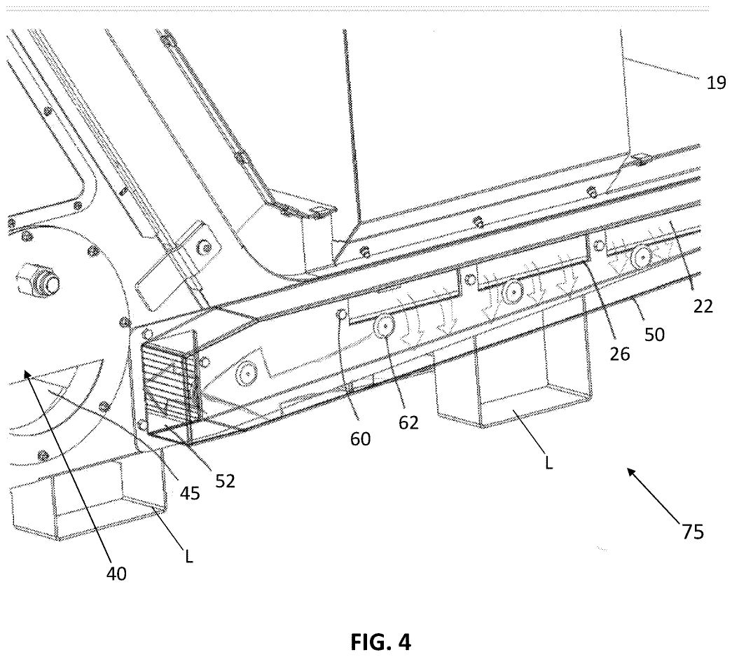

Referring now to FIG. 4, there is illustrated a detailed view of the flume/trough system 50. During operation of material separating system 75, liquid and solid materials 20 that do not get discharged by the upper run 14a of the conveyor belt 12a enter intermediate conveyor area 22. Without a successful way to manage and/or expel liquid and solid materials 20 out of the intermediate conveyor area 22, material buildup can occur that can expedite wear of internal components, cause damage to integral parts, and jamming and/or failure. The flume/trough system 50 functions as a gateway for material 20 to exit the intermediate conveyor area 22 so as to effectively minimize material buildup and maintain integrity of the material separating system 75 performance and longevity. When liquid and solid materials 20 move into the intermediate conveyor area 22, the liquid and solid materials 20 pass through frame slot openings 26 into the flume/trough system 50. The liquid and solid materials 20 then travel, in the present non-limiting embodiment, from right to left towards and through the trough exit opening 52. The liquid and solid materials 20 then travel to a scrap management source, which in the present non-limiting embodiment is a filter assembly that includes drum assembly 40 having a filter. The filter assembly includes a fluid opening 45 that allow filter liquid to exit the filter assembly. The flume/trough system 50 can be optionally secured to the first and/or second conveyor systems 10a, 10b by attachments including but not limited to fasteners, screws, or bolts 60; however, other arrangements can be used. One or more of the attachments 60 can optionally be housed inside of the flume/trough system 50, and the one or more of the attachments 60 can be accessed through the holes by removing plugs 62; however, other arrangements can be used. In the present non-limiting embodiment, the flume/trough system 50 is modular and can be fixed at different angles, height, and lengths which adds flexibility to be low profile and/or maximize liquid flow while managing solid materials out of the intermediate conveyor area 22. As illustrated in FIG. 4, the bottom surface of the flume/trough system 50 slopes downwardly from right to left to facilitate in causing the liquid and solid materials 20 to travel in a desired speed toward the filter system so as to properly convey the solid materials in the liquid and solid materials 20 to the filter system. The angle of slope can optionally be adjustable to obtain the desired speed of movement of the liquid and solid materials 20 to the filter system.

The use of the flume/trough system 50 advantageously aids in cleaning the intermediate conveyor area 22 of liquid and solid materials 20, thereby alleviating expediting wear of critical components, jamming, and/or conveyor and machine failure. It is to be appreciated that the flume/trough system 30 functions the same or similar manner and includes the same or similar components as that of the flume/trough system 50.

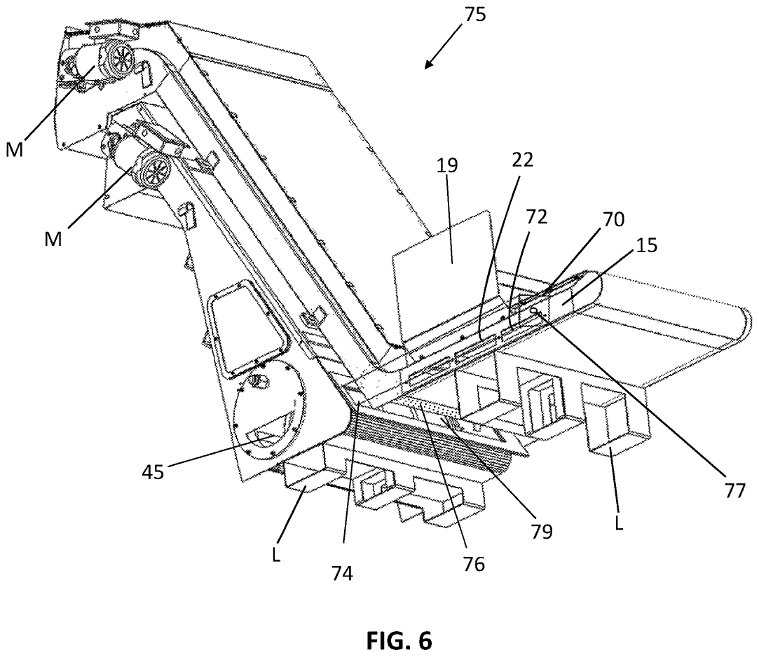

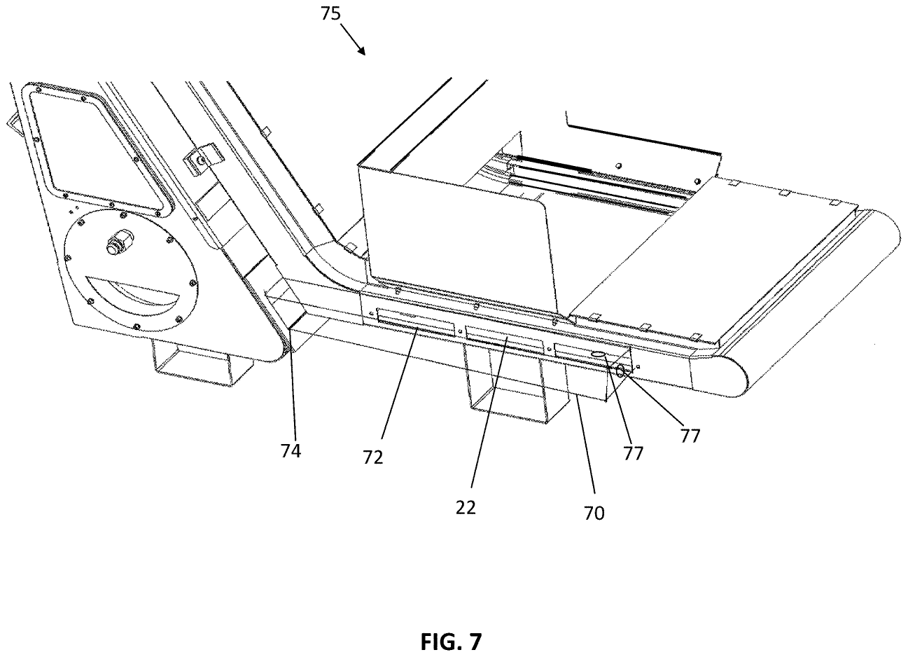

Referring now to FIGS. 5-7, another non-limiting exemplary flume/trough system 70 that is configured for use with material separating system 75. The flume/trough system 70 functions similarly and includes similar components to that of the flume/trough systems 30, 50, the difference being that the flume/trough system 70 is configured to provide a straight flow of liquid and/or material to the liquid and scrap management source. The flume/trough system 70 is absent the downwardly sloping bottom surface. During operation of the material separating system 75, some of the liquid and solid materials 20 enters the intermediate conveyor area 22 as previously described. The liquid and solid materials 20 that flows into the intermediate conveyor area 22 thereafter flows into the flume/trough system 70 through frame slot holes 72. The liquid and solid materials 20 subsequently travels down the flume/trough system 70 to a scrap and management source such as, but not limited to, a filter arrangement that includes drum assembly 40 with a filter. The flume/trough system 70 is configured to advantageously guide the liquid and solid materials 20 in a substantially straight or linear direction directly into the scrap and management source (e.g., the filter arrangement, etc.). As illustrated in FIG. 6, the flume/trough system 70 can optionally include a plug, coupling, valve, sensor and/or or other type of monitor 77 to allow for a) a fluid pump hookup to increase fluid flow in the flume/trough system 70, and/or b) a sensor or other type of monitor to monitor or sensor fluid flow rates in the flume/trough system 70 and/or fluid levels in the flume/trough system 70. Such an arrangement can be used to a) facilitate in maintaining enough liquid flow velocity through the flume/trough system 70 so as to obtain proper and constant flushing of materials from the flume/trough system 70, b) prevent fluids from overflowing from the flume/trough system 70, which overflow can cause undesired discharge of materials and fluids about the material separating system 75, and/or c) prevent fluids from backing into the intermediate conveyor area 22, which backup can cause undesired discharge of materials and fluids about the material separating system 75, and/or damage components of the material separating system 75, and/or cause a jam in the material separating system 75. As can be appreciated, flume/trough systems 30 and 50 can also optionally include a plug, coupling, valve, sensor and/or other type of monitor 77. In one non-limiting arrangement, a coupling, fitting, and/or valve 77 is provided so that an external pump hookup can be made on the back end of the flume/trough system 70 or any area along the flume/trough system 70 so as to provide additional fluid to the flume/trough system 70 to maintain a desired fluid flow rate in the flume/trough system 70.

The flume/trough system 70 can optionally be connected to the filler arrangement by way of a permanent fixation, mating plate or a mating flange/gasket 74. Effective liquid and solid management of materials maximizes liquid and material exit paths and minimizes material buildup in the intermediate conveyor area 22.

Still referring to FIGS. 5-7, in one or more non-limiting embodiments, one or more perforations 76 are optionally formed in the first conveyor system 10a to enable additional liquid flow out of conveyor system 10a and to a designated liquid and solid material management system. As can be appreciated, the liquid and/or materials flowing through the optional perforations 76 can optionally flow into flume/trough system 70 at or near the filler arrangement.

As illustrated in FIG. 6, a wide opening access 79 into the filler arrangement can be formed for fluid and material flow from the flume/trough system 70 into the filter arrangement. The size and shape of opening access 79 is non-limiting.

It is to be appreciated that disclosed material separating system 75 can include one or more of the flume/trough system 30, one or more of the flume/trough system 50, and/or one or more of the flume/trough system 70.

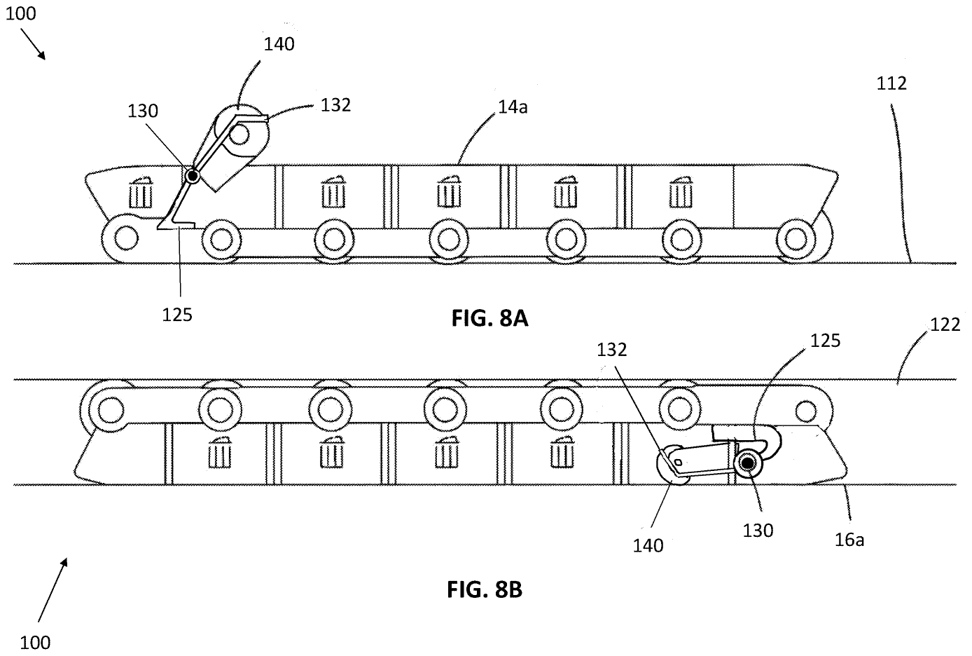

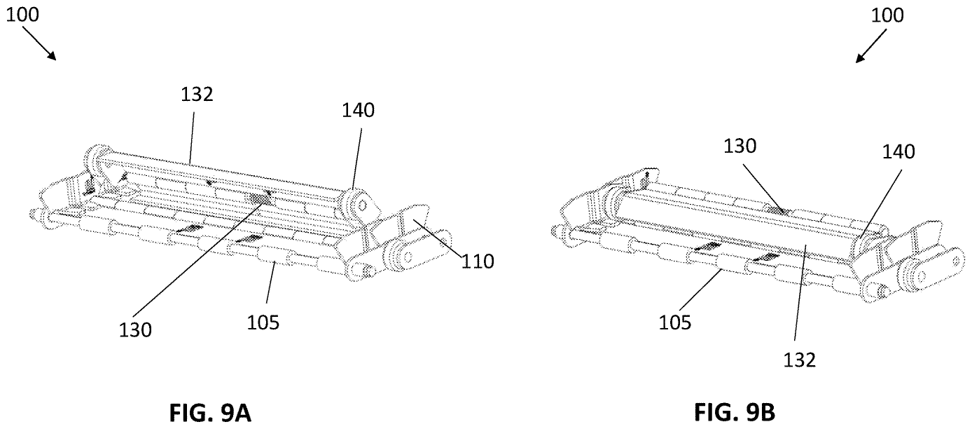

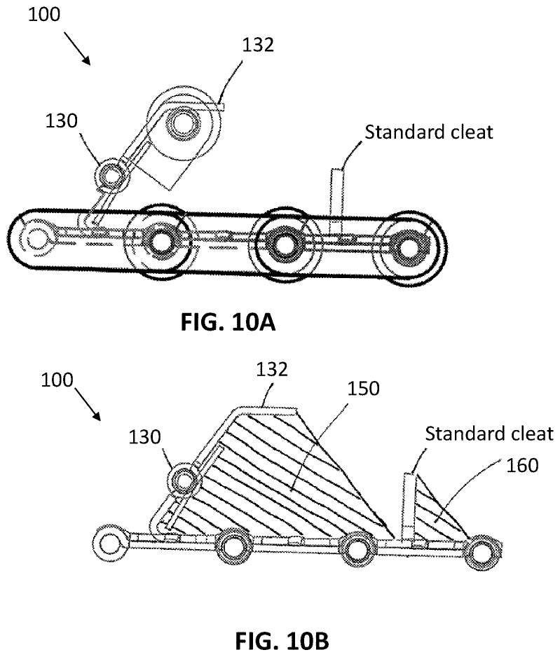

Referring now to FIGS. 8A and 8B, there is illustrated a detailed side view of an optional retractable cleat system that may be used with material separating system 75 or any of the systems disclosed herein. FIGS. 9A and 9B are perspectives view of the retractable cleat system in the raised and retracted positions. FIGS. 10A and 10B are another side view of the retractable cleat system of FIG. 8A that illustrates the increased surface area formed by the retractable cleat system when in the raised position.

With reference to FIGS. 8A-10B, a retractable cleat system 100 is provided. The retractable cleat system 100 is fixed to upper run 14a and lower run 16a of the first conveyor system 10a, and the retractable cleat system 100 travels along upper run track 112 and lower run track 122. In one non-limiting configuration, the retractable cleat system 100 is fixed to upper run 14a and lower run 16a by way of one or more cleat supports 125; however, other or additional arrangements can be used. The retractable cleat system 100 includes a retractable mechanism 130 that is configured to enable the cleat 132 to move between a retracted and a raised position. In one non-limiting configuration, the retractable mechanism 130 includes a spring, coil mechanism, some other biasing arrangement, weight arrangement, etc. When the retractable mechanism 130 causes the cleat 132 to move to the raised position, the cleat 132 raises a predetermined height and angle thereby increasing area above conveyor side wings or side edges 110 as illustrated in FIG. 9A to maximize surface area of materials being grabbed and carried to a discharge area (for example, discharge 18a of material separating system 75). As illustrated in FIG. 9A, the top of retractable cleat 132 is positioned above the side edges 110 when in the raised position. As illustrated in FIGS. 10A and 10B, when the retractable cleat 132 is in the raised position, the height of the retractable cleat 132 is higher than a standard cleat. The retractable cleat 132 is configured to have a height that is equal to or less than a height of a standard cleat when in the retracted position, and have a height that is at least 1.1 times the height (e.g., 1.1-5 times the height and all values and ranges therebetween) of a standard cleat height of a standard cleat when the retractable cleat 132 is in the raised position. The height of the retractable cleat 132 over the top surface of the upper run 14a of the first conveyor system 10a is at least 1.1 times higher (e.g., 1.1-3 times higher and all values and ranges therebetween) than the height of the retractable cleat 132 over the top surface of the run 16a of the first conveyor system 10a. For example, the distance between the first and second conveyor systems 10a and 10b is limited by the height of the cleat. When a standard cleat is used, the distance between the lower run 16a of the first conveyor system 10a and the upper run 14b of the second conveyor 10b must be sufficient to allow the cleat to pass. As such, the height of the standard cleat must be limited so as to not create too large of a space between the first and second conveyor systems 10a and 10b. The retractable cleat 132 in accordance with the present disclosure overcomes this limitation. When the retractable cleat 132 as the retractable cleat passes between the lower run 16a of the first conveyor system 10a and the upper run 14b of the second conveyor 10b, the height created by the retractable cleat 132 is reduced, and when the retractable cleat 132 is in the raised position as the retractable cleat 132 moves along the upper run 14a of the first conveyor system 10a, the retractable cleat 132 is able to capture and retain more material.

As illustrated in FIGS. 10A and 10B, the top portion of retractable cleat 132 has an angle flanged portion to form an open V-shaped cleat shape that is used to capture more material when in the raised position as illustrated in FIG. 10B. FIG. 10A illustrates the volume of material that can be captured by the retractable cleat 132 as illustrated in the cross-hatching 150 as compared to the volume of material that can be captured by the standard cleat as illustrated in the cross-hatching 160. The volume of material that can be captured by the retractable cleat 132 in the raised position is at least 1.1 times the volume (e.g., 1.1-10 times the volume and all values and ranges therebetween) of the volume of material that can be captured by the standard cleat.

The angled top portion of the retractable cleat 132 also facilitates in trapping and retaining material under a portion of the retractable cleat 132 as the materials is moved on the upper run 14a.

Such systems in operations with heavy metal cutting applications increases surface area of the cleat to grab higher volumes of material and thus alleviating a “tumble back” occurrence. It is desirable to obtain high volume of chips to the discharge area to alleviate unwanted wear of parts, jamming, or other occurrences that can damage the conveyor or surrounding environments. It is a feature used to contain materials causing for safer working environments and prevent failure of immediate or surrounding equipment.

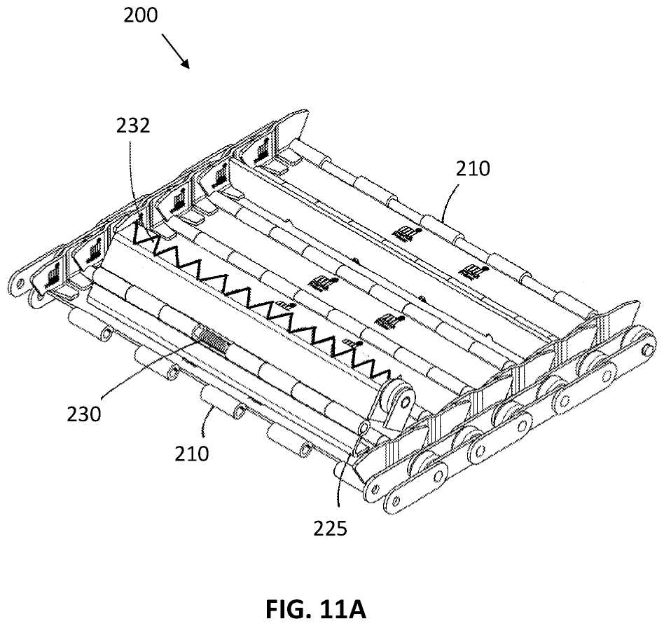

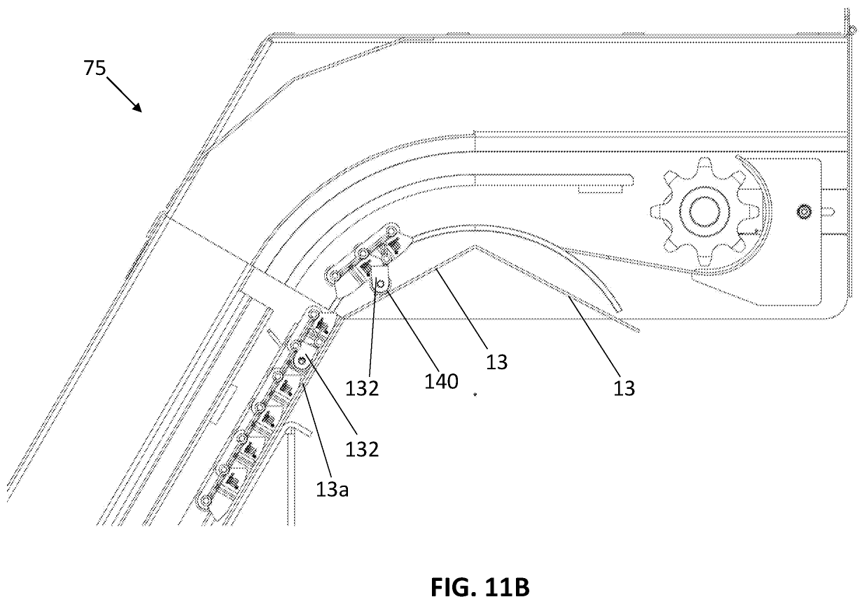

Still referring to FIGS. 8-10, when the upper run 14a transitions to the lower run 16a, the retractable mechanism 130 retracts and/or compresses the cleat 132 close to belt pan 105 to minimize stress on the lower run 120 and/or the lower run track 122 as illustrated in FIG. 11A. One or more roller assemblies 140 may also be included on the retractable cleat system 100 to provide a padded buffer that aids in the cleat's retraction motion in addition to alleviating pressure of the retractable cleat 132 from rubbing on the lower run 120 and/or the lower run track 122, thereby reducing friction and wear. In one or more embodiments, the one or more roller assemblies 140 are formed of, but not limited to, UHMW material, steel, and or other material types.

Referring now to FIG. 11B, the retractable cleat 132 are illustrated as moving from the raised position to the retracted position as the retractable cleat 132 moves about the upper end of the upper run 14a and moves along the beginning of the lower run 16a. The frame of the first conveyor system 10a is illustrated as including angled flanges 13 at the top region of the first conveyor system 10a that are configured to engage the roller assemblies 140 to cause the retractable cleat 132 to move from the raised to the retracted position. The frame of the first conveyor system 10a is illustrated as having straight flanges 13a that are configured to maintain the retractable cleat 132 in the retracted position as the retractable cleat 132 travels along the lower run 16a. When the retractable cleat 132 again transitions from the lower run 16a to the upper run 14a, the roller assemblies 140 disengages from flanges 13a and the retractable mechanism 130 of the retractable cleat 132 causes the retractable cleat 132 to move from the retracted position to the raised position. As can be appreciated, other arrangements can be used to cause the retractable cleat 132 to move between the raised and retracted positions.

In heavy machining operations, for example, where there is a high amount of solid and liquid materials that need to be discharged, the performance of the cleats can be affected if there is insufficient surface area to grab materials along the upper run 14a and carry the material out effectively to the designated discharge area. The retractable cleat system 100 in accordance with the present disclosure advantageously expands the surface area allowable for more materials to be grabbed and carried to the discharge area. Inadequate forms of material management may result in issues with containment and diminish performance in operations. As such, maximizing the area to manage materials result in better performing applications with heavy loaded materials.

Referring now to FIGS. 11A & B, there is illustrated another exemplary retractable cleat system 200 that may be used with material separating system 75 or any of the systems disclosed herein. The retractable cleat system 200 includes similar features and functions similar to that of the retractable cleat system 100, the difference being that the retractable cleat system 200 includes one or more serrated extended cleats 232 with one or more teeth. When the retractable mechanism 230 is extended, the serrated extended cleat 232 raises to maximize surface area of materials being grabbed and carried to the discharge area. The retractable cleat system 200 is affixed to the belt pan assembly 210 by one or more cleat supports 225. In operations with or without heavy “fine” volumes or light “ball-like” and “stringy” material, standard straight flat cleats can be unsuccessful in grabbing and conveying such material. The serrated extended cleat 232 adds sharp means to grab and pull such materials a certain distance and/or up incline conveyor sections to discharge (end of run) or any other material management source. In one or more non-limiting embodiments, the serrated retractable cleat system 200 represents an effective solution of “string-like” materials where a flat surface may not grab and pull material to the designated areas as effectively. It is to be appreciated that any of the components disclosed herein with respect to the retractable cleat system 100 can be used with the retractable cleat system 200, and vice versa.

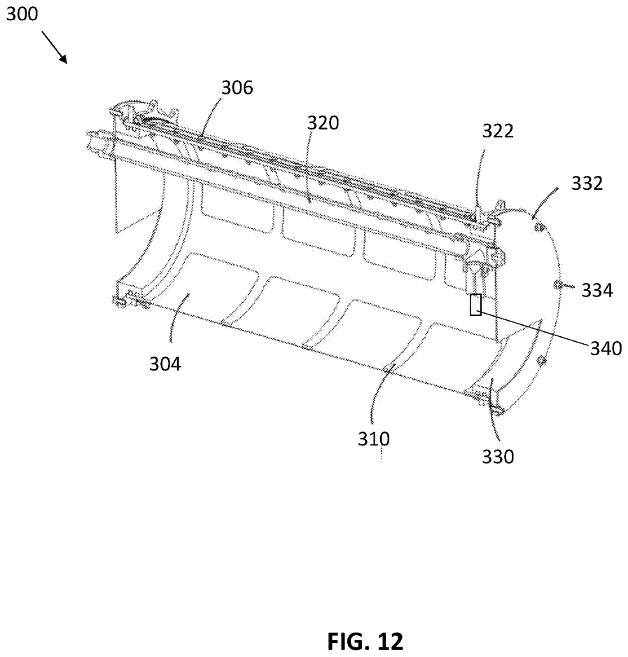

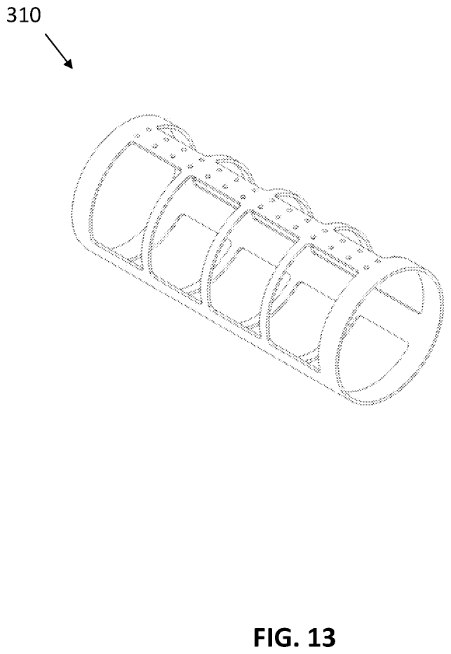

Referring now to FIG. 12, there is illustrated a cross-sectional view of an exemplary filter system in the form of a filter system 300 that may be configured for use with material separating system 75 or any of the systems disclosed herein. FIG. 13 depicts an exemplary drum cage 310 of the filter system 300.

With reference to FIGS. 12-13, filter system 300 includes drum assembly 40 formed of a drum cage 310 that has a filter material 304 in the form of a filter panel material that is wrapped about the drum cage 310. The filter panel 304 is secured by fasteners (bolts, nuts, screws, etc.) 306 to the drum cage 310. As liquid or solid material (e.g., similar to liquid or solid material 20 of FIG. 1) flows through the filter panel 304, solid particles that are larger than the filter mesh sizing (e.g., 1-200 microns, etc.) are blocked and clean liquids passes through the filter panel 304. The drum cage 310 has a generally cylindrical shape; however, other shapes can be used. The filter panel 304 is connected to the outer surface of the drum cage 310; however, it can be appreciated that the filter panel 304 can be connected to the inner surface and/or outer surface of the drum cage 310. The material used to form the filter panel 304 and the drum cage 310 is non-limiting (e.g., metal, plastic, polymers, fibers, etc.). In operation, the liquid and materials collected by the one or more flume/trough systems 30, 50, 70 are directed into the filter system wherein the liquid and material engages the drum cage 310 and filter panel 304. The filtered liquid is able to pass through the filter panel 304 and then exit the drum cage 310 via fluid openings 45 on one or both ends of the drum cage 310. The material that cannot pass through the filter panel primarily falls to the bottom 23 of the frame cavity 21 that contains the filter system 300. The material on bottom 23 is then grabbed or pushed along the bottom of the frame cavity and then up along the bottom wall of the cavity by the one or more cleats on the lower run 16b until the material is discharged at 18b by the second conveyor system 10b.

The drum cage 310 optionally at least partially houses a spray bar 320 that sits stationary within the drum cage 310 and periodically or continuously sprays filter panel 304 from the inside out (through filter) with liquid to clean and knock off material that has adhered to or is lodged or otherwise connected to the outer surface of the material of the filter panel 304. In operation, the spray bar 320 that includes one or more spay nozzles periodically or continuously sprays to as the drum cage 310 rotates about its longitudinal central axis so as to clean the filter panel 304 of solid materials larger than the set filter panel 304 screen type/size. As illustrated in FIG. 12, the spray bar 320 is located at the top portion of the drum cage near the inner surface of the filter panel 304 (e.g., spaced from the central longitudinal axis of the drum cage 310); however, this is not required. In operation, the drum cage 310 is configured to rotate about its central longitudinal axis and the stationary spray bar 320 directs liquid onto the filter panel 304 as the drum cage rotates, thereby resulting in the continuous cleaning of the filter panel 304. The chain of the second conveyor system 10b conveyor, during operation, is configured to engage sprocket 322 to thereby cause the rotation of the drum cage 310 of the filter system 300 as the chain moves so as to effect the cleaning of the filter panel 304 by the spray bar 320.

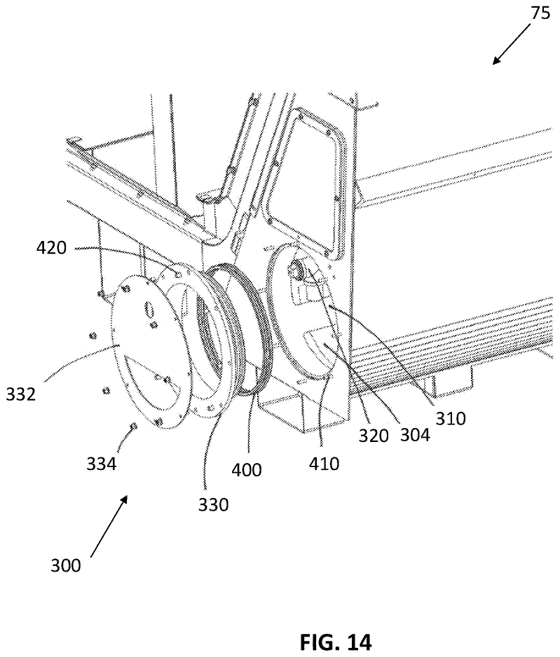

Referring now to FIG. 14, the end regions of one or both sides of the filter system 300 can optionally include a grooved UHMW or steel drum bearing 330 that is clamped on with an end cap 332 with fasteners (nuts, bolts, screws, etc.) 334. Such arrangement of the filter system 300 advantageously requires less components, less machining, and less assembly as compared to conventional drum systems, while providing easier access to the components of the filter system 300 components for purposes of maintenance, repair, replacement, cleaning, and serviceability. The filter system 300 in accordance with the present disclosure enables the operators to access the components of the filter system 300 with minimal effort and at a fraction of the time (as compared to similar designs) resulting in more profitable uptime in machining operations. Simple access to the components of the filter system 300 results to quick troubleshooting and yearly preventative maintenance replacement duties.

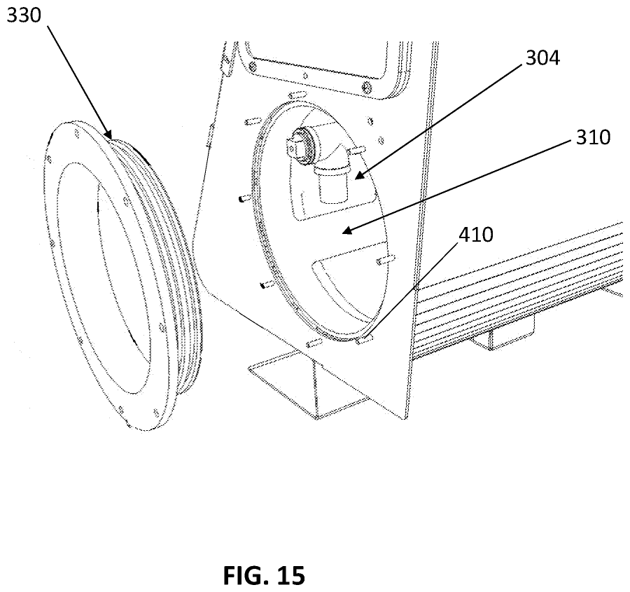

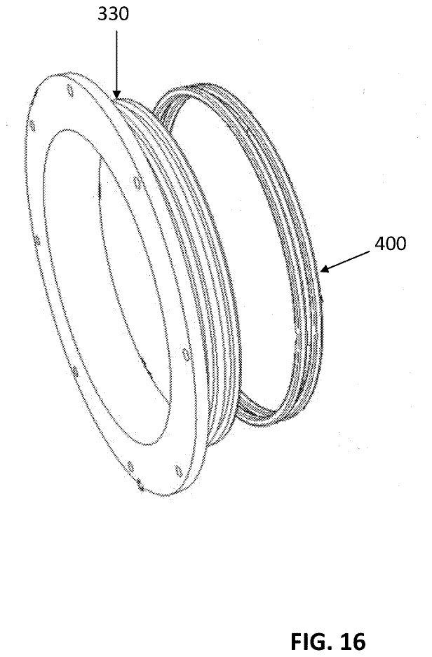

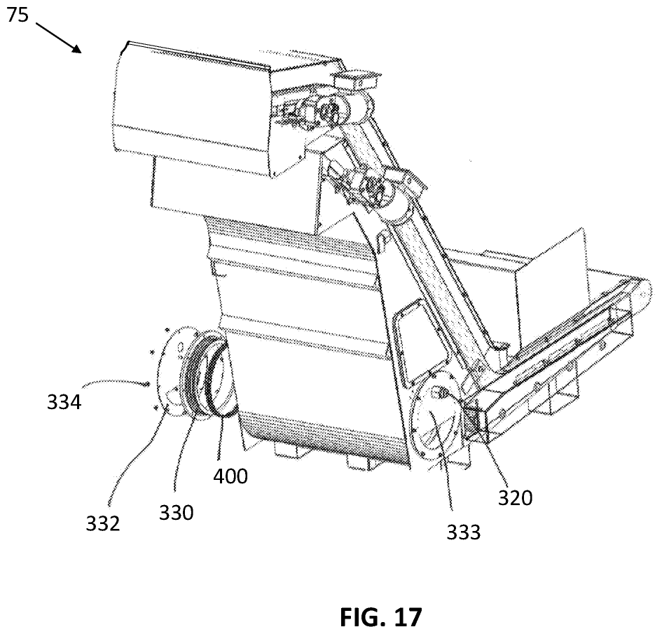

As illustrated in FIG. 14, a partially exploded view of the filter system 300 and external components as illustrated, wherein the filter system 300 is configured for use with the material separating system 75. FIG. 15 illustrates the bearing 330 being removed from the filter system 300. FIG. 16 depicts an exemplary wear component gasket seal 400 that is configured for use with the bearing 330. FIG. 17 is another perspective view of the filter system and external components of FIG. 14. With reference to FIGS. 14-17, gasket seal 400 sits in one or more sets of grooves formed on bearing 330 to seal liquid and solid material from leakage. The bearing 330, with the gasket seal 400 thereon, is secured to filter system 300 by way of screws or similar fasteners 410. The end cap 332 then connects to bearing 330 by way of standoffs 420. Fasteners (nuts, bolts, screws, etc.) 334 then seal all components together. As illustrated in FIG. 17, the filter system 300 further includes a second end cap 333. The filter system 300 provides accessibility to wear and seal components alleviating extensive labor efforts for repairs and preventative maintenance. As maintenance is needed, fittings such as screws, nuts, bolts, or other, can be quickly disconnected for access to seal replacement and other internal wear parts. Such configuration significantly decreases labor time and increases uptime of operation, as most conventional systems require disassembly of full conveyor units to gain access to the filter systems. Simple disconnections of, but not limited to, screw, nuts, bolts, or other gains faster access to wear components like the gasket seal 400 for quick replacement and repair to increase uptime of machine operations.

The filter arrangement can optionally include one or more monitors or sensors 340 to a) monitor flow rates into and/or out of the filter system 300 to i) determine if proper rates of filtering are occurring by the filter system 300, ii) determine if the filter material is being properly cleaned so as to increase/decrease liquid flush flows (e.g., increase/decrease liquid flow through the spray bar 320) for filter material cleaning, and/or iii) determine if filter material needs to be cleaned or replaced; and/or b) monitor particle size of materials in the liquid exiting the filter system to determine if the filter material is damaged and thereby allowing too large of particles to remain in the cleaned liquid.

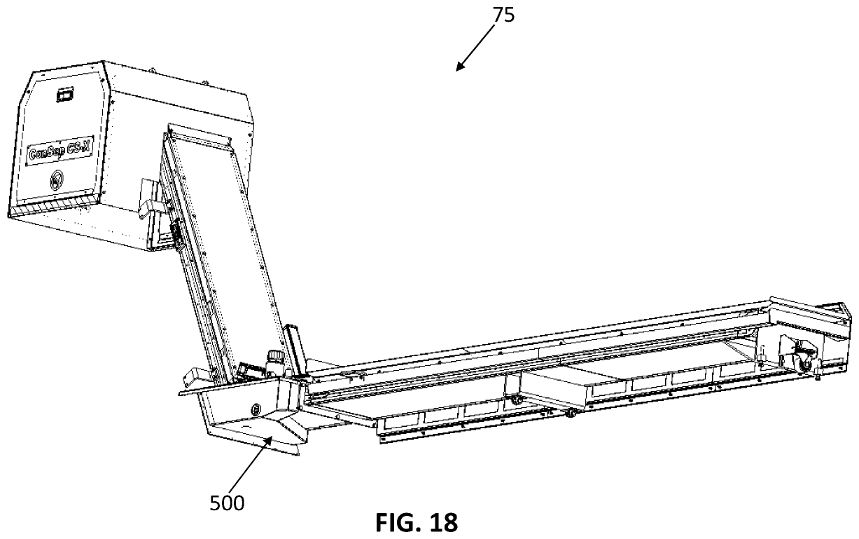

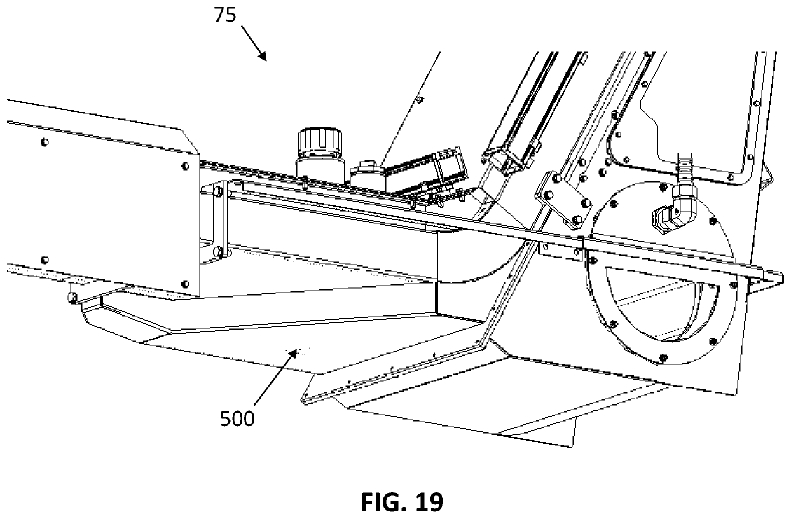

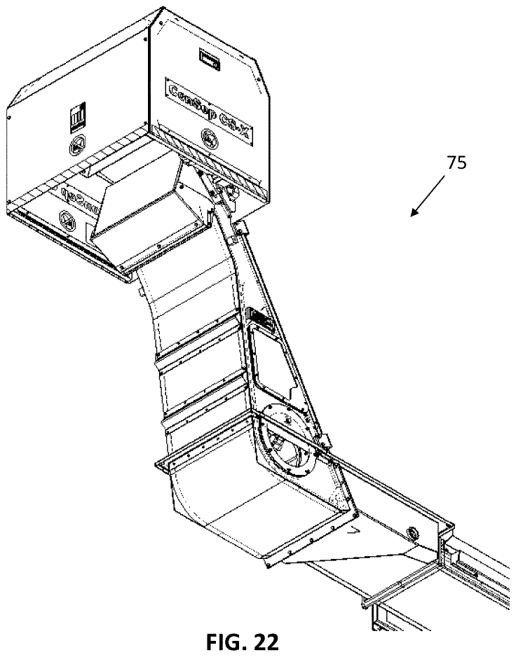

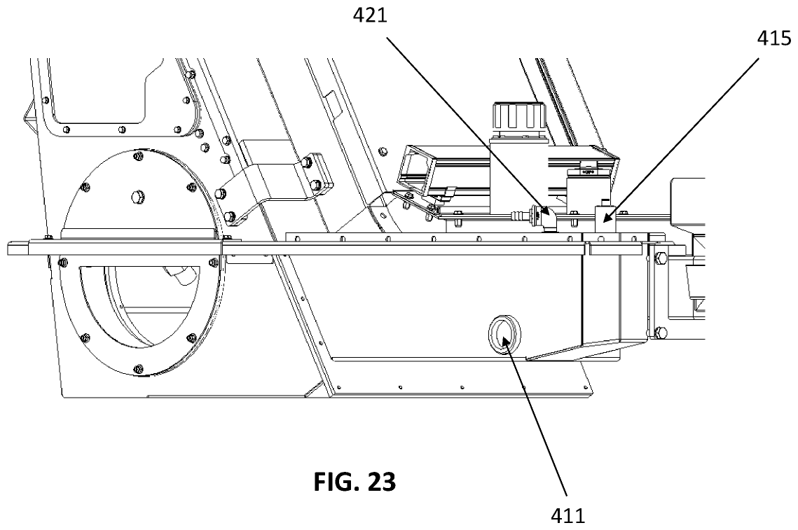

Referring now to FIGS. 18-24, there is illustrate another non-limiting embodiment of material separating system 75 that illustrates alternate views/footprints of an optional flange/trough mounting system as described in FIGS. 1-7. It will be appreciated that the retractable cleat system, the filter system, and flume/trough system illustrated in FIGS. 1-17 and described above can be incorporated in the material separating system 75 that is illustrated in FIGS. 18-24. As such, these components and features will not be repeated herein.

FIGS. 18-24 illustrate material separating system 75 that includes a bottom-combined flume/trough system 500. This configuration enables an increased coolant flow rate into the filter system 400 and facilitates the transfer of a greater chip volume from the first conveyor to the second conveyor. This configuration can also reduce overall maintenance requirements due to the increased effective surface area.

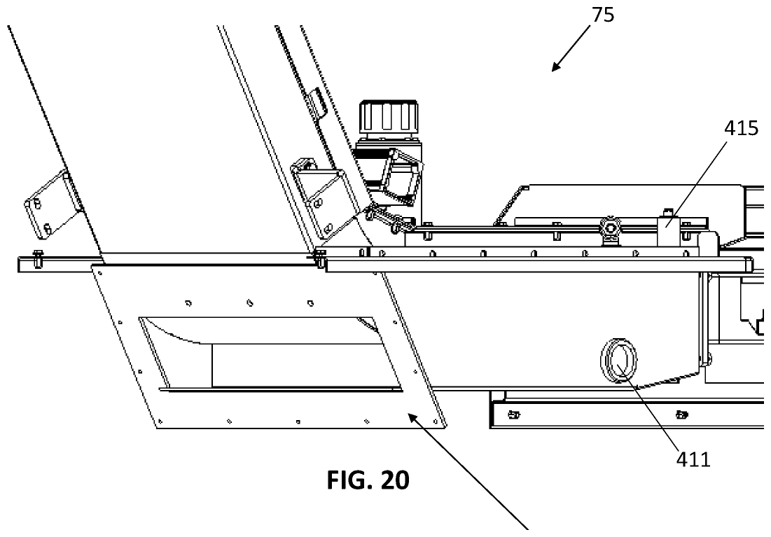

Referring now to FIG. 20, there is illustrated a maintenance access opening 411 configured to facilitate in the periodic cleaning of the flume/trough system. Also illustrated is a level sensor 415 on the flume/trough system 500. The level sensor 415 can be used monitor fluid levels and/or fluid flow rates in the flume/trough system 500 so as to inhibit or prevent overflow in the flume/trough system 500, and/or to cause an increase in liquid flow into the flume/trough system 500. The level sensor 415 can also be used to control the rate of liquid and solid material 20 that is added to the material separating system 75 so as to not starve or overload the material separating system 75 with liquid and solid material 20.

FIG. 20 also illustrates a coupling, fitting, and/or valve 421 that can be used to connect a liquid supply to the flume/trough system 500. The coupling, fitting, and/or valve can be used to enable additional liquid to be added to the flume/trough system 500 to enable flushing of chips, sludge and/or other materials from the flume/trough system 500 to the filter system. The level sensor can optionally be used to start and/or stop additional flow into the flume/trough system 500 via the one or more coupling 421, and/or to cause a decrease and/or increase in the flowrate of liquid into the flume/trough system 500 via the one or more coupling 421.

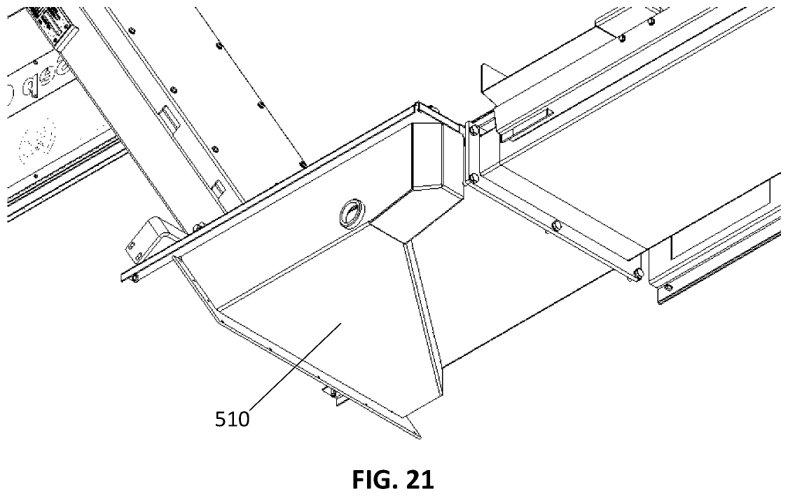

Referring now to FIG. 21, there is illustrated the merging interface 510 between the first and second conveyors, which ensures efficient coolant and chip transfer while maintaining a leak-free design. Mating gasket 425, as illustrated in FIG. 20, mates with secondary filtration conveyor 10b. The mating gasket 425 can be formed of a variety of materials such as, but not limited to, foam, rubber, or adhesive gasket to securely. This alternate in-line chute/trough system ensures a greater area for material to flow from primary conveyor 10a to secondary filtration conveyor 10b or other external filter system.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

It will thus be seen that the objects set forth above, among those made apparent from the preceding description, are efficiently attained, and since certain changes may be made in the constructions set forth without departing from the spirit and scope of the disclosure, it is intended that all matter contained in the above description and illustrated in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the certain embodiments. These and other modifications of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

To aid the Patent Office and any readers of this application and any resulting patent in interpreting the claims appended hereto, Applicant does not intend any of the appended claims or claim elements to invoke 35 U.S.C. 112(f) unless the words “means for” or “step for” are explicitly used in the particular claim.

1. A conveyor system for processing a pourable conveying material; said conveyor system comprising:
a first conveyor; said first conveyor includes a first frame and a first endless belt having a first upper run and a first lower run; said first frame at least partially supports said first endless belt; said first conveyor is configured to convey at least a portion of a conveying material in a first conveying direction; said first endless belt is configured to enable at least a portion of liquid in the conveying material to pass through said first endless belt;
a second conveyor; said second conveyor includes second frame and a second endless belt having a second upper run and a second lower run; said second frame at least partially supports said second endless belt; said second conveyor is configured to convey at least a portion of the conveying material in a second conveying direction; said second endless belt is configured to enable at least a portion of liquid in the conveying material to pass through said second endless belt;
an intermediate conveyor area that is configured to receive at least a portion of the conveying material; said intermediate conveyor area at least partially defined as a region between said first upper run of said first conveyor and said second lower run of said second conveyor; said intermediate conveyor area includes a base that is positioned under said second lower run of said second conveyor and one or more side walls; said intermediate conveyor area includes one or more side openings in said one or more side walls; and
a trough system; said trough system is configured to receive at least a portion of the conveying material that pass from said intermediate conveyor area through said one or more side openings in said intermediate conveyor area; said trough system is configured to convey the conveying material that enters said trough system to a storage facility or filter system.

2. The conveyor system as defined in claim 1, wherein said trough system includes a first trough that is connected to one of said side walls of said intermediate conveyor area.

3. The conveyor system as defined in claim 2, wherein said first trough has a sloped bottom surface used to facilitated in the flow of material towards the storage facility or the filter system.

4. The conveyor system as defined in claim 1, wherein said trough system includes fluid connector arrangement that is configured to connect to a secondary liquid source to be connected to said trough system so as to add liquid to said trough system.

5. The conveyor system as defined in claim 1, wherein said trough system includes a first sensor arrangement; said first sensor arrangement is configured to monitor liquid levels in said trough system and/or fluid flow rates in said trough system.

6. The conveyor system as defined in claim 5, wherein said first sensor arrangement provides information to a control system, and wherein said control system is configured to i) cause additional liquid to be added to said trough system to maintain certain liquid volumes and/or flow rates in said trough system, and/or ii) increase or decrease a volume of the pourable conveying material added to said conveyor system so to I) inhibit or prevent overloading and/or causing overflowing of fluid and material from said trough system, II) prevent fully filling and/or causing an overflow said intermediate conveyor area, and/or III) inhibit or prevent starving or unacceptable low flow rates or low volumes of liquid in said trough system.

7. The conveyor system as defined in claim 2, wherein said first trough includes one or more walls to form an enclosure for the liquid in said first trough to inhibit or prevent the conveying material in said first trough from flowing out said first trough until the conveying material exits at fluid exit of said first trough.

8. The conveyor system as defined in claim 1, further including a filter system; said filter system fluidly connected to said trough system to receive at least a portion of the conveying material from said trough system.

9. The conveyor system as defined in claim 8, wherein said trough system includes a fluid exit that is connected to said filter system; said fluid exit has a width that is at least 90% of a width of a cavity of said filter system.

10. The conveyor system as defined in claim 8, wherein said filter system includes a rotatable filter drum and a filter flushing arrangement; said rotatable filter drum is configured to rotate about a longitudinal axis of said rotatable filter drum; said rotatable filter drum includes a drum frame and a filter material; said filter material formed on and/or connected to said drum frame; said filter flushing arrangement is configured to direct a fluid toward said rotatable filter drum to cause materials from the conveying material that are adhering to said drum filter to be removed from said drum filter.

11. The conveyor system as defined in claim 10, wherein said filter flushing arrangement is configured to remain stationary while said rotatable filter drum rotates about said longitudinal axis of said rotatable filter drum.

12. The conveyor system as defined in claim 10, wherein said filter system includes one or more removable outer caps, one or more removable bearings, and/or one or more removable seals that are accessible from an exterior side of said first and/or second conveyors to enable a user to remove said one or more removable outer caps, said one or more bearings, and/or said one or more seals to access and remove said drum filter without having to disassemble said first and/or second endless belts.

13. The conveyor system as defined in claim 10, wherein said rotatable filter drum engages a portion of said second endless belt; movement of said second endless belt is configured to cause said rotatable filter drum to rotate about a longitudinal axis of said rotatable filter drum.

14. The conveyor system as defined in claim 8, wherein said filter system includes one or more monitors or sensors; said one or more monitors or sensors are configured to perform one or more functions selected from the group consisting of a) monitoring flow rates into and/or out of said filter system to i) determine if proper rates of filtering are occurring by said filter system, ii) determine if a filter material in said filter system is being properly cleaned and to cause adjustments in liquid flush flows based on such information, and/or iii) determining if said filter material needs to be cleaned or replaced; and/or b) monitoring particle size of materials in liquid exiting said filter system to determine if said filter material is damaged and/or not properly filter said material.

15. The conveyor system as defined in claim 1, wherein said first endless belt includes one or more retractable cleat systems; each of said retractable cleat system includes a base cleat portion that is connected to said first endless belt, and upper cleat portion, and a biasing and/or hinge arrangement that is connected to said base cleat portion and said upper cleat portion and is configured to enable said upper cleat portion to move between a retracted position and a raised position; a maximum height of said upper cleat portion from a top surface of said first endless belt in said raised position is greater than a maximum height of said upper cleat portion from a top surface of said first endless belt in said retracted position.

16. The conveyor system as defined in claim 15, wherein said upper cleat portion includes a roller to facilitate in movement of said retractable cleat system when said upper cleat portion is in said retracted position.

17. The conveyor system as defined in claim 16, wherein said first frame of said first conveyor includes one or more engagement structures that are configured to engage a portion of said upper cleat portion to cause said upper cleat portion to move from said raised position to said retracted position as said retractable cleat moves between said first upper run to said first lower run.

18. The conveyor system as defined in claim 15, wherein said upper cleat portion of one or more of said retractable cleat systems includes a tooth configuration and/or other non-constant linear shape along a width of said retractable cleat.

19. A method for separating solid materials from a pourable liquid and solid material mixture comprising:
providing a conveyor system; said conveyor system comprising:
a first conveyor; said first conveyor includes a first frame and a first endless belt having a first upper run and a first lower run; said first frame at least partially supports said first endless belt; said first conveyor is configured to convey at least a portion of a conveying material in a first conveying direction; said first endless belt is configured to enable at least a portion of liquid in the conveying material to pass through said first endless belt;
a second conveyor; said second conveyor includes second frame and a second endless belt having a second upper run and a second lower run; said second frame at least partially supports said second endless belt; said second conveyor is configured to convey at least a portion of the conveying material in a second conveying direction; said second endless belt is configured to enable at least a portion of liquid in the conveying material to pass through said second endless belt;
an intermediate conveyor area that is configured to receive at least a portion of the conveying material; said intermediate conveyor area at least partially defined as a region between said first upper run of said first conveyor and said second lower run of said second conveyor; said intermediate conveyor area includes a base that is positioned under said second lower run of said second conveyor and one or more side walls; said intermediate conveyor area includes one or more side openings in said one or more side walls; and
a trough system; said trough system is configured to receive at least a portion of the conveying material that pass from said intermediate conveyor area through said one or more side openings in said intermediate conveyor area; said trough system is configured to convey the conveying material that enters said trough system to a storage facility or filter system;
pouring said pourable liquid and solid material mixture onto at least a portion of said upper run of said first endless belt of said first conveyor;
operating said first conveyor to cause said upper run to move larger solid materials to a first material discharge for said first conveyor;
enabling liquid and smaller solid materials to pass about and/or through said first endless belt and to flow into said intermediate conveyor area;
enabling said liquid and smaller solid materials in said intermediate conveyor area to flow through said one or more side openings and into said trough system; and
directing a flow of said liquid and smaller solid materials in said trough system to said to a storage facility or to said filter system.

20. The method as defined in claim 19, wherein said trough system includes a first trough that is connected to one of said side walls of said intermediate conveyor area.

21. The method as defined in claim 20, wherein said first trough includes one or more of a) a sloped bottom surface used to facilitated in the flow of material towards the storage facility or the filter system, b) fluid connector arrangement that is configured to connect to a secondary liquid source to be connected to said trough system so as to add liquid to said trough system, c) a first sensor arrangement; said first sensor arrangement is configured to monitor liquid levels in said trough system and/or fluid flow rates in said trough system, and/or d) one or more walls to form an enclosure for the liquid in said first trough to inhibit or prevent the conveying material in said first trough from flowing out said first trough until the conveying material exits at fluid exit of said first trough.

22. The method as defined in claim 21, wherein said trough system includes said first sensor arrangement; said first sensor arrangement provides information to a control system, and wherein said control system is configured to i) cause additional liquid to be added to said trough system to maintain certain liquid volumes and/or flow rates in said trough system, and/or ii) increase or decrease a volume of the pourable conveying material added to said conveyor system so to I) inhibit or prevent overloading and/or causing overflowing of fluid and material from said trough system, II) prevent fully filling and/or causing an overflow said intermediate conveyor area, and/or III) inhibit or prevent starving or unacceptable low flow rates or low volumes of liquid in said trough system.

23. The method as defined in claim 19, further including a filter system; said filter system fluidly connected to said trough system to receive at least a portion of the conveying material from said trough system.

24. The method as defined in claim 23, wherein said trough system includes a fluid exit that is connected to said filter system; said fluid exit has a width that is at least 90% of a width of a cavity of said filter system.

25. The method as defined in claim 23, wherein said filter system includes one or more removable outer caps, one or more removable bearings, and/or one or more removable seals that are accessible from an exterior side of said first and/or second conveyors to enable a user to remove said one or more removable outer caps, said one or more bearings, and/or said one or more seals to access and remove said drum filter without having to disassemble said first and/or second endless belts.

26. The method as defined in claim 23, wherein said filter system includes a rotatable filter drum and a filter flushing arrangement; said rotatable filter drum is configured to rotate about a longitudinal axis of said rotatable filter drum; said rotatable filter drum includes a drum frame and a filter material; said filter material formed on and/or connected to said drum frame; said filter flushing arrangement is configured to direct a fluid toward said rotatable filter drum to cause materials from the conveying material that are adhering to said drum filter to be removed from said drum filter.

27. The method as defined in claim 26, wherein said filter flushing arrangement is configured to remain stationary while said rotatable filter drum rotates about said longitudinal axis of said rotatable filter drum.

28. The method as defined in claim 26, wherein said rotatable filter drum engages a portion of said second endless belt; movement of said second endless belt is configured to cause said rotatable filter drum to rotate about a longitudinal axis of said rotatable filter drum.

29. The method as defined in claim 23, wherein said filter system includes one or more monitors or sensors; said one or more monitors or sensors are configured to perform one or more functions selected from the group consisting of a) monitoring flow rates into and/or out of said filter system to i) determine if proper rates of filtering are occurring by said filter system, ii) determine if a filter material in said filter system is being properly cleaned and to cause adjustments in liquid flush flows based on such information, and/or iii) determining if said filter material needs to be cleaned or replaced; and/or b) monitoring particle size of materials in liquid exiting said filter system to determine if said filter material is damaged and/or not properly filter said material.

30. The method as defined in claim 19, wherein said first endless belt includes one or more retractable cleat systems; each of said retractable cleat system includes a base cleat portion that is connected to said first endless belt, and upper cleat portion, and a biasing and/or hinge arrangement that is connected to said base cleat portion and said upper cleat portion and is configured to enable said upper cleat portion to move between a retracted position and a raised position; a maximum height of said upper cleat portion from a top surface of said first endless belt in said raised position is greater than a maximum height of said upper cleat portion from a top surface of said first endless belt in said retracted position.

31. The method as defined in claim 30, wherein said upper cleat portion includes a roller to facilitate in movement of said retractable cleat system when said upper cleat portion is in said retracted position.

32. The method as defined in claim 30, wherein said first frame of said first conveyor includes one or more engagement structures that are configured to engage a portion of said upper cleat portion to cause said upper cleat portion to move from said raised position to said retracted position as said retractable cleat moves between said first upper run to said first lower run.

33. The method as defined in claim 30, wherein said upper cleat portion of one or more of said retractable cleat systems includes a tooth configuration and/or other non-constant linear shape along a width of said retractable cleat.
